(19) United States
(12) Patent Application Publication
(10) Pub. No.: US 2017/0215453 A1
(43) Pub. Date: Aug. 3, 2017

(54) TEMPERED CHOCOLATE PRINTING SYSTEM, KIT AND RELATED METHOD

(71) Applicant: The Research Foundation for the State University of New York, Albany, NY (US)

(72) Inventors: Adam R. CARLOCK, Poughkeepsie, NY (US); Kimberly A. EAGLESTON, Kingston, NY (US); Mitchell Zachary WAGNER, Thiells, NY (US)

(73) Assignee: The Research Foundation for the State University o f New York, Albany, NY (US)

(21) Appl. No.: 15/418,198

(22) Filed: Jan. 27, 2017

Related U.S. Application Data
(60) Provisional application No. 62/288,144, filed on Jan. 28, 2016.

(51) Int. Cl. A23G 1/50; A23G 1/00; A23G 1/04

(52) U.S. Cl. CPC A23G 1/50; A23G 1/04; A23G 1/0003; A23V 2002/00

(57) ABSTRACT

The present application provides a system or kit for printing tempered chocolate. The system includes a first heated vessel for maintaining chocolate therein untempered, and a second heated vessel in fluid communication with the first heated vessel for maintaining chocolate therein within the range of about 84 degrees Fahrenheit and about 92 degrees Fahrenheit and tempered with about 0.5% to about 3% type V crystals. The system further includes a syringe pump configured to pump tempered chocolate and a nozzle. The system further includes a three-way valve for selectively coupling the syringe pump and the second vessel, or the nozzle and the syringe pump, in fluid communication to direct the tempered chocolate from the second vessel through the nozzle. The system further includes a control system for controlling the system such that the chocolate flowing from the nozzle includes greater than about 3% type V crystals.

### CROSS REFERENCE TO RELATED APPLICATION

This application claims priority benefit under 35 U.S.C. §119(e) to U.S. Provisional Application No. 62/288,144, filed Jan. 28, 2016, and entitled Tempered Chocolate Printing System, Kit and Related Method, the entirety of which is incorporated herein by reference in its entirety.

### FIELD OF THE INVENTION

The present disclosure is generally directed to printing tempered chocolate confections. More particularly, the present disclosure is directed to tempered chocolate printing systems and kits for layer-based, additive manufacturing printing of chocolate confections with desirable crystalline structures.

### BACKGROUND OF THE INVENTION

Some compounds can have a different crystalline structure depending on one or more factors, such as the temperature of the compound from which it solidifies. For example, chocolate, and more particularly cocoa butter within chocolate, can generally have one of six crystal or crystalline structures depending on how it is produced. The crystal structures of chocolate range from type I to type VI, with each crystal type having a different melting point. Generally accepted melting points of cocoa butter crystal types are as follows: type I: 61-67° F.; type II: about 71-73° F.; type III: about 77-78° F.; type IV: about 81-84° F.; type V: about 92-95° F.; and type VI: about 97-98° F.

Quality chocolate with type V crystal structures has desirable characteristics, such as a shiny surface, a firm texture, a good snap, a melting point which is above typical ambient temperatures but generally around human body temperature, and a texture and appearance which will not degrade over time. The process of treating chocolate to achieve a particular cocoa butter crystal type(s) is known generally as tempering.

Typically, tempering is accomplished by first heating the chocolate to a temperature sufficient to melt all six forms of crystals (e.g., dark chocolate may be heated to about 120° F., milk chocolate may be heated to about 115° F., and white chocolate may be heated to about 110° F.). The chocolate is then cooled to a temperature that forms the desirable type V crystals, and agitated to encourage the crystallization process. During further cooling, any type V crystals within the chocolate act as crystallization nuclei, around which other type V crystals form.

Another method involves heating the chocolate to a temperature that forms the desirable type V crystals, and then agitated to create the seed type V crystals. The chocolate is then heated to eliminate any type IV crystals (e.g., dark chocolate may be heated to about 90° F., milk chocolate may be heated to about 86° F., and white chocolate may be heated to about 82° F.), thereby leaving just the type V crystals.

In both of these ways, substantially all undesirable crystals may be removed from the chocolate, and the chocolate is brought to a temperature in which the desirable type V crystals will form and agitated to produce seed type V crystals that act as crystallization nuclei.

Attempts have been made to fashion three dimensional designs with chocolate using a chocolate 3D printer. Generally, 3D printing is an additive manufacturing process used to build 3D objects in a layer-by-layer manner. For example, printing a 3D object from a digital representation of the 3D object may be accomplished by forming the object in a layer-by-layer manner by extruding a flowable modeling material. The modeling material is usually extruded through an extrusion tip carried by an extrusion head, and is deposited as a sequence of roads on a substrate in an x-y plane. The extruded modeling material fuses to previously deposited modeling material, and solidifies upon a drop in temperature thereof after being deposited. The position of the extrusion head relative to the substrate is then incremented along a z-axis (perpendicular to the x-y plane), and the process is then repeated to form the 3D object resembling the digital representation.

However, prior attempts to utilize such 3D printing technology has required the chocolate to be heated to a temperature above the type V and/or type VI crystal structure melting points for the chocolate to flow with sufficient ease for printing. As discussed above, heating chocolate to these printing temperatures causes the chocolate to lose temper (i.e., melts and destroys the attractive type V). However, at lower temperatures that protect the attractive type V crystal structures, the viscosity of the chocolate has commonly prevented successful printing. Current 3D chocolate printers have thereby failed to produce a chocolate printing medium with cocoa butter type V crystal structures. Current systems and methods of chocolate printing thereby produce chocolate confections that lack the prerequisite resistance to elevated temperatures, and other desirable consumer properties of snap, surface finish and texture.

Further, some current 3D chocolate printers typically include a recirculation loop that recirculates tempered or over-tempered chocolate back through at least a portion of the print process. This process thereby re-tempers at least a portion of the chocolate. The recirculation loop typically is utilized to prevent over-tempered chocolate from fouling the printer and/or to control the temper of chocolate that is further upstream of the printing process. Recirculation loops rely solely on temperature to control the re-tempering of chocolate, which is an inexact process that can lead to a runaway process of over-tempering and/or destruction of attractive crystal structures. For example, particular “high” temperatures will break down the crystallization of a particular type of chocolate, but not at exact crystallization % to temperature ratios. A variance of a degree or less of such a “high” temperature in re-temper recirculation loops can cause a very inconsistent, and/or disproportionate difference in the amount of crystallization breakdown. Re-temper recirculation loops can thereby cause the temper of the chocolate flowing from the nozzle to significantly fluctuate and lead to the formation of inconsistent or disparate crystallization layers.

Accordingly, tempered chocolate printing systems, kits and methods for layer-based, additive manufacturing printing of chocolate confections with desirable crystalline structures are needed.

### SUMMARY OF THE INVENTION

In one aspect, the present disclosure provides a system for printing tempered chocolate. The system includes a first vessel, a second vessel, a syringe pump, a nozzle including an opening, and a three-way valve. The system forms a direct flow of tempered chocolate from the second vessel through the opening of the nozzle. The first vessel includes a first cavity, and is configured to maintain chocolate within the first cavity at a temperature within the range of about 100 degrees Fahrenheit and about 120 degrees Fahrenheit such that the chocolate is untempered. The second vessel includes a second cavity in fluid communication with the first cavity of the first vessel, and is configured to maintain tempered chocolate within the second cavity at a temperature within the range of about 84 degrees Fahrenheit and about 92 degrees Fahrenheit and a crystallization within the range of about 0.5% to about 3% type V crystals. The syringe pump includes a hollow barrel portion and a plunger portion movable within the barrel portion. The barrel portion and the plunger portion cooperate to form a third cavity of a first predefined volume in a first arrangement of the barrel portion and the plunger portion, and a second predefined volume that is less than the first predefined volume in a second arrangement of the barrel portion and the plunger portion. The three-way valve is configured to selectively include a first state with the third cavity of the syringe pump in fluid communication with the second vessel and a second state with the nozzle in fluid communication with the third cavity of the syringe pump. The syringe pump is configured to selectively translate at least one of the hollow barrel portion and the plunger portion with respect to the other from the second arrangement to the first arrangement when the three-way valve is in the first state to draw the tempered chocolate from the second vessel into the third cavity, and to selectively translate at least one of the hollow barrel portion and the plunger portion with respect to the other from the first arrangement to the second arrangement when the three-way valve is in the second state to extrude the tempered chocolate through opening of the nozzle.

In some embodiments, the second vessel is configured to maintain tempered chocolate within the second cavity at a crystallization within the range of about 1% to about 2% type V crystals. In some embodiments, the system continuously tempers the tempered chocolate from the second vessel through the opening of the nozzle. In some such embodiments, the tempered chocolate flowing though the opening of the nozzle includes a crystallization greater than 3%.

In some embodiments, the system further comprises a pump configured to pump a portion of the untempered chocolate of the first vessel into the second vessel such that the crystallization of the tempered chocolate within the second vessel is maintained within the range of about 0.5% to about 3% type V crystals. In some embodiments, the system further includes at least one output line configured to direct a flow of untempered chocolate from the first cavity of the first vessel to the second cavity of the second vessel. In some such embodiments, the at least one output line includes at least one heating mechanism configured to maintain the tempered chocolate therein at a temperature within the range of about 100 degrees Fahrenheit and about 120 degrees Fahrenheit such that the chocolate is untempered. In some such embodiments, the at least one output line includes at least one temperature measurement mechanism configured to detected the temperature of at least the at least one heating mechanism, and the system further includes a control system configured to control the temperature of the at least one heating mechanism based on the temperature detected by the at least one temperature measurement mechanism.

In some embodiments, the system further includes at least one tempered output line configured to direct a flow of tempered chocolate from the second cavity of the second vessel to the three-way valve. In some such embodiments, the at least one tempered output line includes at least one heating mechanism configured to maintain the tempered chocolate therein at a temperature within the range of about 80 degrees Fahrenheit and about 88 degrees Fahrenheit and a crystallization within the range of about 0.5% to about 3% type V crystals. In some such embodiments, the at least one tempered output line includes at least one temperature measurement mechanism configured to detected the temperature of at least the at least one heating mechanism, and the system further includes a control system configured to control the temperature of the at least one heating mechanism based on the temperature detected by the at least one temperature measurement mechanism. In some embodiments, the syringe pump includes at least one heating mechanism configured to maintain the tempered chocolate within the third cavity at a temperature within the range of about 80 degrees Fahrenheit and about 88 degrees Fahrenheit and a crystallization within the range of about 0.5% to about 3% type V crystals. In some such embodiments, the syringe pump includes at least one temperature measurement mechanism configured to detected the temperature of at least the at least one heating mechanism, and the system further includes a control system configured to control the temperature of the at least one heating mechanism based on the temperature detected by the at least one temperature measurement mechanism.

In some embodiments, the system further includes at least one nozzle input line configured to direct a flow of tempered chocolate from the three-way valve to the nozzle. In some such embodiments, the at least one nozzle input line includes at least one heating mechanism configured to maintain the tempered chocolate therein at a temperature within the range of about 75 degrees Fahrenheit and about 84 degrees Fahrenheit and a crystallization within the range of about 0.5% to about 3% type V crystals. In some such embodiments, the at least one nozzle input line includes at least one temperature measurement mechanism configured to detected the temperature of the at least one heating mechanism, and the system further includes a control system configured to control the temperature of the at least one heating mechanism based on the temperature detected by the at least one temperature measurement mechanism. In some embodiments, the at least one of the first and second vessels include a heating mechanism configured to maintain the temperature of the chocolate therein. In some such embodiments, the at least one of the first and second vessels include a temperature measurement mechanism positioned exterior to the first and second cavities, respectively, configured to detect the temperature of the heating mechanism thereof.

In some embodiments, the at least one of the first and second vessels include a temperature measurement mechanism positioned interior of the first and second cavities, respectively, configured to detect the temperature of the chocolate therein. In some embodiments, at least one of the first and second vessels include an agitation mechanism configured to agitate the chocolate contained therein. In some embodiments, the system further includes a cooling system configured to control the temperature and/or humidity of the environment about at least the opening of the nozzle.

In some embodiments, the system further includes a control system configured to selectively translate the hollow barrel portion and the plunger portion of the syringe pump between the first and second arrangements, to selectively activate the first and second states of the three-way valve, and to control the first and second vessels. In some such embodiments, the system includes at least one first line configured to direct the flow of untempered chocolate from the first vessel to the second vessel, at least one second line configured to direct the flow of tempered chocolate from the second vessel to the three-way valve, and at least one third line configured to direct the flow of tempered chocolate from the three-way valve to the nozzle. In some other such embodiments, the system includes at least one heating mechanism configured to heat the chocolate within at least one of the at least one first line, the at least one second line and the at least one third line, and at least one temperature measurement mechanism configured to detected the temperature of at least the at least one heating mechanism, wherein the control system controls the temperature of the at least one heating mechanism based on the temperature detected by the at least one temperature measurement mechanism. In some other such embodiments, the system includes a microprocessor. In some embodiments, the system includes a 3D printer including a housing, a build plate, a nozzle translation mechanism coupled to the nozzle configured to translate the nozzle in three dimensions with respect to the build plate, and a printer controller configured to control the nozzle translation mechanism based on computer readable instructions.

In another aspect, the present disclosure provides a kit for printing tempered chocolate with a 3D printer including a build plate, a nozzle translation mechanism configured to translate in three dimensions with respect to the build plate, and a printer controller configured to control the nozzle translation mechanism based on computer readable instructions. The kit includes a first vessel, a second vessel, a syringe pump, a nozzle including an opening configured to couple with the nozzle translation mechanism, and a three-way valve and a temper controller. The kit is configured to form a direct flow of the tempered chocolate from the second vessel through the opening of the nozzle. The first vessel includes a first cavity, and configured to maintain chocolate within the first cavity at a temperature within the range of about 100 degrees Fahrenheit and about 120 degrees Fahrenheit such that the chocolate is untempered. The second vessel includes a second cavity connectable in fluid communication with the first cavity of the first vessel, the second vessel configured to maintain tempered chocolate within the second cavity at a temperature within the range of about 84 degrees Fahrenheit and about 92 degrees Fahrenheit and a crystallization within the range of about 0.5% to about 3% type V crystals. The syringe pump includes a hollow barrel portion and a plunger portion movable within the barrel portion. The barrel portion and the plunger portion cooperate to form a third cavity of a first predefined volume in a first arrangement of the barrel portion and the plunger portion, and a second predefined volume that is less than the first predefined volume in a second arrangement of the barrel portion and the plunger portion. The three-way valve is configured to selectively include a first state with the third cavity of the syringe pump in fluid communication with the second vessel and a second state with the nozzle in fluid communication with the third cavity of the syringe pump. The temper controller is configured to communication with the printer controller and, based on the computer readable instructions, to selectively activate the first state of the three-way valve and translate at least one of the hollow barrel portion and the plunger portion of the syringe pump with respect to the other from the second arrangement to the first arrangement to draw tempered chocolate from the second vessel into the third cavity. The temper controller is also configured to, based on the computer readable instructions, selectively activate the second state of the three-way valve and translate at least one of the hollow barrel portion and the plunger portion with respect to the other from the first arrangement to the second arrangement to extrude tempered chocolate through the opening of the nozzle.

In some embodiments, the second vessel is configured to maintain tempered chocolate within the second cavity at a crystallization within the range of about 1% to about 2% type V crystals. In some embodiments, the kit continuously tempers the tempered chocolate from the second vessel through the opening of the nozzle. In some such embodiments, the tempered chocolate flowing though the opening of the nozzle includes a crystallization greater than 3%. In some embodiments, the kit further includes a pump configured to pump a portion of the untempered chocolate of the first vessel into the second vessel such that the crystallization of the tempered chocolate within the second vessel is maintained within the range of about 0.5% to about 3% type V crystals.

In some embodiments, the kit further includes at least one output line configured to direct a flow of untempered chocolate from the first cavity of the first vessel to the second cavity of the second vessel. In some such embodiments, the at least one output line includes at least one heating mechanism configured to maintain the tempered chocolate therein at a temperature within the range of about 100 degrees Fahrenheit and about 120 degrees Fahrenheit such that the chocolate is untempered. In some such embodiments, the at least one output line includes at least one temperature measurement mechanism configured to detected the temperature of at least the at least one heating mechanism, and wherein the kit further comprises a control system configured to control the temperature of the at least one heating mechanism based on the temperature detected by the at least one temperature measurement mechanism.

In some embodiments, the kit further includes at least one tempered output line configured to direct a flow of tempered chocolate from the second cavity of the second vessel to the three-way valve. In some such embodiments, the at least one tempered output line includes at least one heating mechanism configured to maintain the tempered chocolate therein at a temperature within the range of about 80 degrees Fahrenheit and about 88 degrees Fahrenheit and a crystallization within the range of about 0.5% to about 3% type V crystals. In some such embodiments, the at least one tempered output line includes at least one temperature measurement mechanism configured to detected the temperature of at least the at least one heating mechanism, and the kit further includes a control system configured to control the temperature of the at least one heating mechanism based on the temperature detected by the at least one temperature measurement mechanism.

In some embodiments, the syringe pump includes at least one heating mechanism configured to maintain the tempered chocolate within the third cavity at a temperature within the range of about 80 degrees Fahrenheit and about 88 degrees Fahrenheit and a crystallization within the range of about 0.5% to about 3% type V crystals. In some such embodiments, the syringe pump includes at least one temperature measurement mechanism configured to detected the temperature of at least the at least one heating mechanism, and the kit further includes a control system configured to control the temperature of the at least one heating mechanism based on the temperature detected by the at least one temperature measurement mechanism. In some embodiments, the kit further includes at least one nozzle input line configured to direct a flow of tempered chocolate from the three-way valve to the nozzle. In some such embodiments, the at least one nozzle input line includes at least one heating mechanism configured to maintain the tempered chocolate therein at a temperature within the range of about 75 degrees Fahrenheit and about 84 degrees Fahrenheit and a crystallization within the range of about 0.5% to about 3% type V crystals. In some such embodiments, the at least one nozzle input line includes at least one temperature measurement mechanism configured to detected the temperature of the at least one heating mechanism, and the kit further includes a control system configured to control the temperature of the at least one heating mechanism based on the temperature detected by the at least one temperature measurement mechanism.

In some embodiments, the at least one of the first and second vessels includes a heating mechanism configured to maintain the temperature of the chocolate therein. In some such embodiments, at least one of the first and second vessels includes a temperature measurement mechanism positioned exterior to the first and second cavities, respectively, configured to detect the temperature of the heating mechanism thereof. In some embodiments, at least one of the first and second vessels includes a temperature measurement mechanism positioned interior of the first and second cavities, respectively, configured to detect the temperature of the chocolate therein. In some embodiments, at least one of the first and second vessels includes an agitation mechanism configured to agitate the chocolate contained therein. In some embodiments, the kit further includes a cooling system configured to control the temperature and/or humidity of the environment about at least the opening of the nozzle.

In some embodiments, the kit further includes a control system configured to selectively translate the hollow barrel portion and the plunger portion of the syringe pump between the first and second arrangements, to selectively activate the first and second states of the three-way valve, and to control the first and second vessels. In some such embodiments, the kit further includes at least one first line configured to direct the flow of untempered chocolate from the first vessel to the second vessel, at least one second line configured to direct the flow of tempered chocolate from the second vessel to the three-way valve, and at least one third line configured to direct the flow of tempered chocolate from the three-way valve to the nozzle. In some other such embodiments, the kit further includes at least one heating mechanism configured to heat the chocolate within at least one of the at least one first line, the at least one second line and the at least one third line, and at least one temperature measurement mechanism configured to detected the temperature of at least the at least one heating mechanism, wherein the control system controls the temperature of the at least one heating mechanism based on the temperature detected by the at least one temperature measurement mechanism. In some other such embodiments, the control system includes a microprocessor. In some embodiments, the kit includes a 3D printer including a housing, a build plate, a nozzle translation mechanism coupled to the nozzle configured to translate the nozzle in three dimensions with respect to the build plate, and a printer controller configured to control the nozzle translation mechanism based on computer readable instructions.

In another aspect, the present disclosure provides a method of printing tempered chocolate. The method includes maintaining chocolate within a first cavity of a first vessel at a temperature within the range of about 100 degrees Fahrenheit and about 120 degrees Fahrenheit such that the chocolate is untempered. The method further includes maintaining tempered chocolate within a second cavity of a second vessel in fluid communication with the first cavity at a temperature within the range of about 84 degrees Fahrenheit and about 92 degrees Fahrenheit and a crystallization within the range of about 0.5% to about 3% type V crystals. The method further includes selectively activating a first state of a three-way valve to couple a syringe pump in fluid communication with the second vessel. The method further includes translating at least one of a hollow barrel portion and a plunger portion of the syringe pump with respect to the other to draw tempered chocolate from the second vessel into a third cavity of the syringe pump. The method further includes selectively activating a second state of the three-way valve to couple the syringe pump in fluid communication with a nozzle. The method further includes translating at least one of the hollow barrel portion and the plunger portion of the syringe pump with respect to the other to extrude tempered chocolate through an opening of the nozzle. The method forms a direct flow of the tempered chocolate from the second vessel through the opening of the nozzle.

In some embodiments, the method further includes translating the nozzle during the extrusion of the tempered chocolate through the opening of the nozzle. In some embodiments, the method further includes maintaining the tempered chocolate within the second cavity of the second vessel at a crystallization within the range of about 1% to about 2% type V crystals. In some embodiments, the method further includes continuously tempering the tempered chocolate from the second vessel through the opening of the nozzle. In some embodiments, the tempered chocolate flowing though the opening of the nozzle includes a crystallization greater than 3%. In some embodiments, the maintaining tempered chocolate within a second cavity includes pumping a portion of the untempered chocolate of the first vessel into the second vessel.

In some embodiments, the method further includes directing a flow of untempered chocolate from the first cavity of the first vessel to the second cavity of the second vessel via at least one output line, and maintaining the tempered chocolate within the at least one output line at a temperature within the range of about 100 degrees Fahrenheit and about 120 degrees Fahrenheit such that the chocolate is untempered. In some embodiments, the method further includes detecting the temperature of at least the at least one heating mechanism of the at least one output line via at least one temperature measurement mechanism, and controlling the temperature of the at least one heating mechanism based on the temperature detected by the at least one temperature measurement mechanism via a control system. In some embodiments, the method further includes directing a flow of tempered chocolate from the second cavity of the second vessel to the three-way valve via at least one tempered output line, and maintaining the tempered chocolate within the at least one tempered output line at a temperature within the range of about 80 degrees Fahrenheit and about 88 degrees Fahrenheit and a crystallization within the range of about 0.5% to about 3% type V crystals. In some embodiments, the method further includes maintaining the tempered chocolate within the third cavity of the syringe pump at a temperature within the range of about 80 degrees Fahrenheit and about 88 degrees Fahrenheit and a crystallization within the range of about 0.5% to about 3% type V crystals.

In some embodiments, the method further includes directing a flow of tempered chocolate from the three-way valve to the nozzle via at least one nozzle input line, and maintaining the tempered chocolate within the at least one nozzle input line at a temperature within the range of about 75 degrees Fahrenheit and about 84 degrees Fahrenheit and a crystallization within the range of about 0.5% to about 3% type V crystals. In some embodiments, the method further includes agitating the chocolate within in at least one of the first and second vessels via an agitation mechanism. In some embodiments, the method further includes controlling the temperature and/or humidity of the environment about at least the opening of the nozzle via a cooling system. In some embodiments, the method further includes utilizing a temper controller in communication with a printer controller of a 3D printer, based on computer readable instructions, to at least one of: selectively activate the first state of a three-way valve; translate at least one of the hollow barrel portion and the plunger portion of the syringe pump with respect to the other to draw the tempered chocolate from the second vessel into the third cavity of the syringe pump; selectively activate the second state of the three-way valve, and; translate at least one of the hollow barrel portion and the plunger portion of the syringe pump with respect to the other to extrude the tempered chocolate through the opening of the nozzle.

These and other objects, features and advantages of this disclosure will become apparent from the following detailed description of the various aspects of the disclosure taken in conjunction with the accompanying drawings.

### BRIEF DESCRIPTION OF THE DRAWINGS

FIG. 1 is an elevational perspective view of an exemplary tempered chocolate printing system and kit according to the present disclosure;

FIG. 2 is a side view of the tempered chocolate printing system and kit of FIG. 1;

FIG. 3 is an elevational perspective view of untempered and tempered supply vessels of the tempered chocolate printing system and kit of FIG. 1;

FIG. 4 is an elevational perspective cutaway view of the untempered and tempered supply vessels of the tempered chocolate printing system and kit of FIG. 1;

FIG. 5 is a side view of a pump assembly of the tempered chocolate printing system and kit of FIG. 1;

FIG. 6 is a front cutaway view of the pump assembly of the tempered chocolate printing system and kit of FIG. 1;

FIG. 7 is an elevational perspective view of the untempered supply vessel, and an enlarged cut-away view of an output line of the untempered supply vessel, of the tempered chocolate printing system and kit of FIG. 1;

FIG. 8 is an elevational perspective view of a valve assembly of the tempered chocolate printing system and kit of FIG. 1;

FIG. 9 is a side view of the valve assembly of the tempered chocolate printing system and kit of FIG. 1;

FIG. 10 is a side view of the valve assembly and a syringe assembly of the tempered chocolate printing system and kit of FIG. 1;

FIG. 11 is an elevational perspective view of the valve assembly and the syringe assembly of the tempered chocolate printing system and kit of FIG. 1;

FIG. 12 is an elevational perspective view of the valve assembly and the syringe assembly, and an enlarged view of a syringe of the syringe assembly, of the tempered chocolate printing system and kit of FIG. 1;

FIG. 13 is a front view of a cooling system of the tempered chocolate printing system and kit of FIG. 1;

FIG. 14 is a side view of the cooling system of the tempered chocolate printing system and kit of FIG. 1; and

FIG. 15 illustrates a control system of the tempered chocolate printing system and kit of FIG. 1.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of parameters are not exclusive of other parameters of the disclosed embodiments. Components, aspects, features, configurations, arrangements, uses and the like described, illustrated or otherwise disclosed herein with respect to any particular figure or embodiment may similarly be applied to any other figure or embodiment disclosed herein.

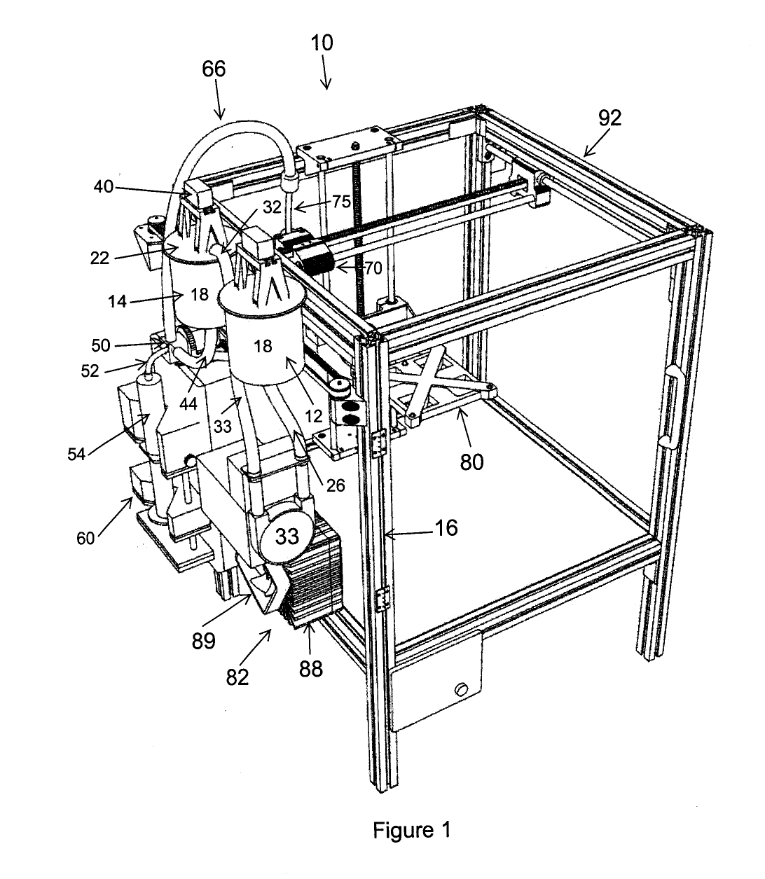

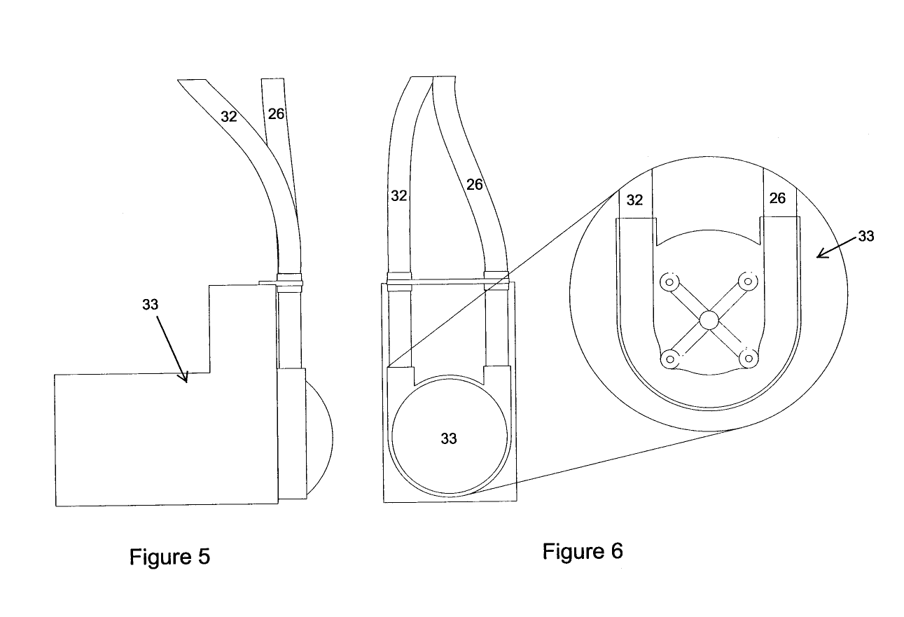

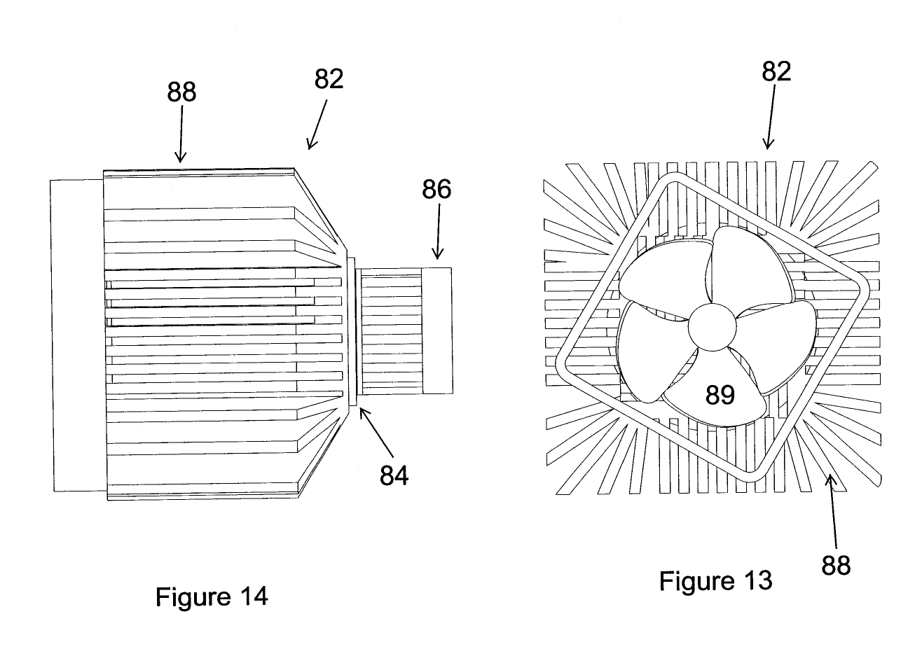

FIGS. 1-15 illustrate an exemplary tempered chocolate printing system and kit 10, and related tempered chocolate printing methods, according to the present disclosure. The system 10 may facilitate or provide a single direction continuous chocolate tempering and printing process, without any need for re-tempering, such that the printer nozzle is supplied with desirable tempered chocolate at all times. Such tempered chocolate may include substantially more than 3% type V crystals upon exiting the print nozzle, which is thereby configured to form addition type V crystals upon cooling and solidification. As the system 10 enables formation of primarily type V cocoa butter crystals in the printed chocolate, it provides a workable consistency, an aesthetically pleasing texture, and a pleasurable mouthfeel. The system 10 may be configured to continuously heating the chocolate such that the chocolate remains smooth and malleable from feed to nozzle. It is noted that the system 10 is capable of printing “true” or “real” chocolate with cocoa butter type V crystals (and the lack of additional binders/oils). However, the system 10 may also print a chocolate-like substance formed by refined sugar, milk solids, cocoa, alkali, artificial flavors, emulsifiers, binders/oils and/or other “fillers.”

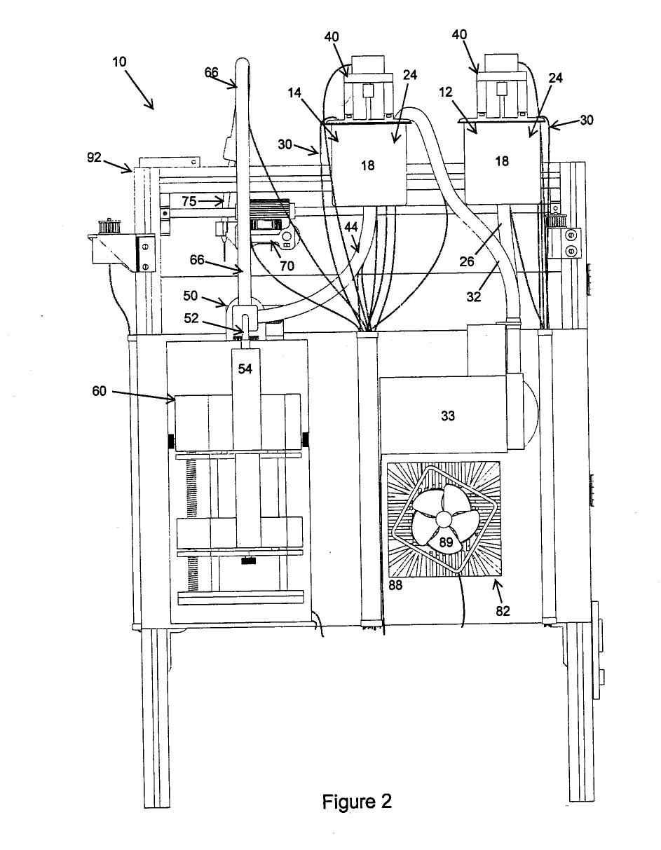

As shown in FIGS. 1-4, the system/kit 10 may include a first chocolate supply vessel 12 and a second chocolate supply vessel 14. The first chocolate supply vessel 12 and the second chocolate supply vessel 14 may be substantially similar to each other, but define separate and distinct vessels. The first chocolate supply vessel 12 and the second chocolate supply vessel 14 may be rigidly affixed to a frame or housing 16, and thereby to each other, as shown in FIGS. 1 and 2. In a kit configuration, the first chocolate supply vessel 12 and the second chocolate supply vessel 14 may be configured to be rigidly affixed to a pre-existing frame or housing 16, and/or to each other. For example, as shown in FIGS. 1 and 2 the first chocolate supply vessel 12 and the second chocolate supply vessel 14 may be affixed or coupled to a frame or housing 16 of a pre-existing 3D printer or printing system. In some embodiments, the first chocolate supply vessel 12 and the second chocolate supply vessel 14 may be bolted, or configured to be bolted, to the fame or housing 16 of a 3D printer.

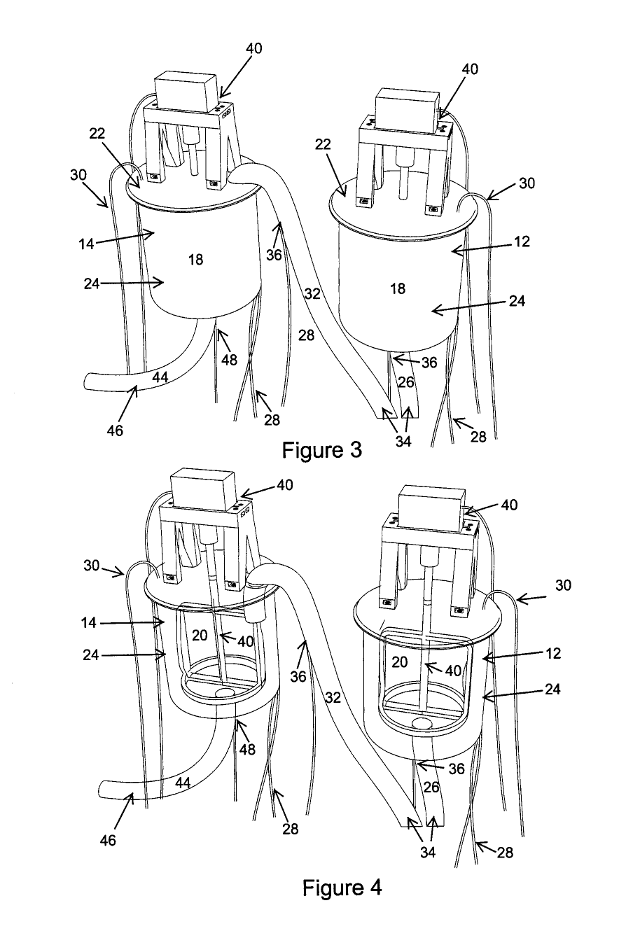

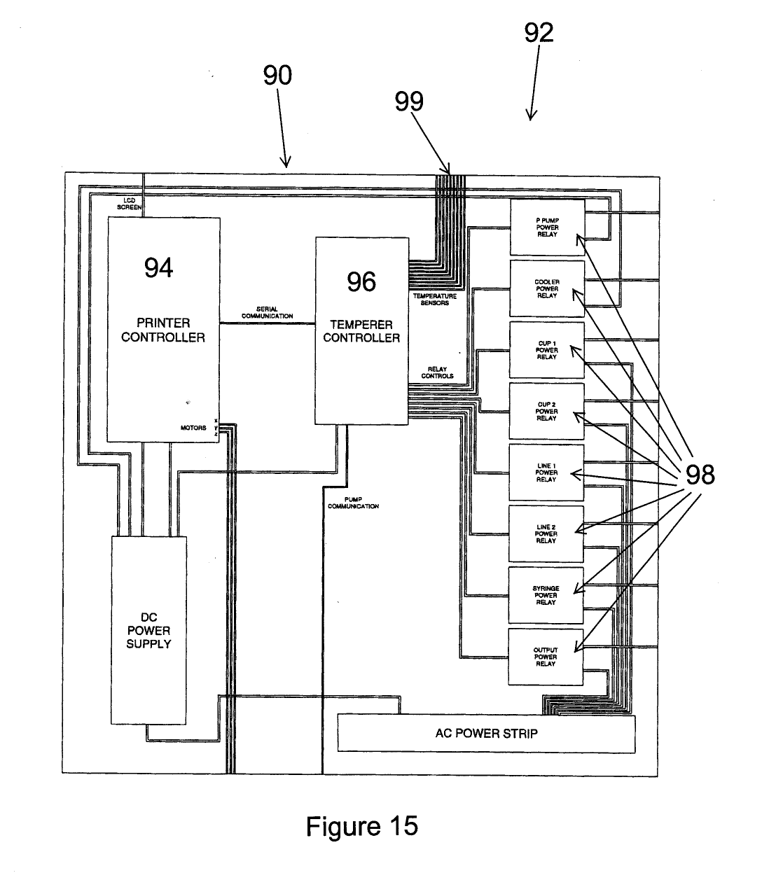

The first chocolate supply vessel 12 and the second chocolate supply vessel 14 may each include a body portion 18 that defined a cavity 20 therein, as shown in FIG. 4. The cavity 20 of the body portion 18 of each of the first chocolate supply vessel 12 and the second chocolate supply vessel 14 may be configured to hold or contain chocolate therein. At least the portion forming the cavity 20 may be made from a food-safe material, such as aluminum or stainless steel. Coupled to the exterior surface of the body portion 18 of each of the first chocolate supply vessel 12 and the second chocolate supply vessel 14 may be a heating mechanism 24, such as a resistive heat sleeve, configured to heat the body portion 18 when energized, as shown in FIGS. 3 and 4. Each of the body portions 18 of the first chocolate supply vessel 12 and the second chocolate supply vessel 14 may further include a temperature measurement mechanism 28, such as a thermistor, that is configured to detect or measure the temperature of the respective heat sleeve 24 and/or the body portion 18 itself. As described further below, the system or kit 10 may include a control system 90 (see FIG. 15) that may operate the temperature measurement mechanisms 28 and heating mechanisms 24 to, ultimately, monitor and/or control the temperature of the body portions 18, and thereby the temperature of chocolate contained within the cavities 20 thereof.

The first chocolate supply vessel 12 and the second chocolate supply vessel 14 may each include a lid portion 22, as shown in FIGS. 1-4. The body portion 18 and the lid portion 22 of each of the first chocolate supply vessel 12 and the second chocolate supply vessel 14 may be configured to mate such that the lid portion 22 substantially seals off the cavity 20 thereof, such as via flanges of the lid portion 22 and the body portion 18. The lid portions 22 may provide for visualization of the cavities 20 when the lid portion 22 is coupled to the body portion 18. For example, the lid portions 22 may include an opening or a transparent or opaque window portion or material. In some embodiments, the lid portions 22 may be formed, at least partially, from Lexan.

As shown in FIGS. 2-4, the system or kit 10 may include another temperature measurement mechanism 30, such as a thermistor, that passes through the lid portions 22 of the first chocolate supply vessel 12 and the second chocolate supply vessel 14 and into the cavities 20 of the body portions 18 thereof. The temperature measurement mechanisms 30 may be configured to detect or measure the temperature within the cavities 20, such as the temperature of chocolate contained within the cavities 20. As the temperature measurement mechanisms 30 may extend through or past the lid portions 22, the temperature measurement mechanisms 30 may be able to detect or measure the temperature of the chocolate therein even when the lid portions 22 are coupled to the body portions 18.

The control system 90 may operate the temperature measurement mechanisms 30 to monitor the temperature of the chocolate within the first chocolate supply vessel 12 and the second chocolate supply vessel 14, and, based on such monitoring, may control the heating mechanisms 24 (and, potentially, the temperature measurement mechanisms 28) to control the temperature of the chocolate contained within the cavities 20. Specifically, the system or kit 10 may be configured such that the heating mechanism 24 of the first chocolate supply vessel 12 maintains the temperature of the chocolate contained within the cavity 20 thereof such that it is, and remains, untempered (i.e., substantially devoid of crystals). In some embodiments, the control system 90 may control or operate the heating mechanism 24 of the first chocolate supply vessel 12 such that it maintains the temperature of the chocolate contained within the cavity 20 thereof within the range of about 100° F. and about 120° F. The first supply vessel 12 may initially be fed with raw chocolate. The system or kit 10 may thereby maintain the temperature of the raw chocolate of the first supply vessel 12 such that it remains substantially untempered or raw, as any crystals therein are melted and broken down. The first supply vessel 12 may therefore be referred to as an “untempered tank” or “raw chocolate tank.”

Each of the first chocolate supply vessel 12 and the second chocolate supply vessel 14 may include an agitation, mixing or stirring assembly 40 associated with the lid portion 22 thereof, as shown in FIGS. 1-4. The agitation assemblies 40 may be configured to extend into the cavity 20 of the respective body portion 18 and agitate the chocolate container therein, as shown in FIG. 4. In some embodiments, the agitation assemblies 40 may be controlled by the control mechanism 90. Each agitation assembly 40 may include a mount extending from the exterior surface of the lid portion 22, a motor supported by the mount, an agitation or mixing member extending into the cavity 20, and a coupler that couples the motor and the agitation or mixing member. The agitation assembly 40 may be configured such that the motor provides motion to the agitation or mixing member, such as rotation, and in turn agitate the chocolate contained within the cavities 20 of the first chocolate supply vessel 12 and the second chocolate supply vessel 14. The control system 90 may be configured to operate the agitation assemblies 40, such as via an electrical connection, to selectively agitate the chocolate contained within the cavities 20 of the first chocolate supply vessel 12 and the second chocolate supply vessel 14.

With reference to FIGS. 1-7, the first supply vessel 12 includes an output line 26 in fluid connection with the bottom or lower portion of the cavity 20, and therefore the untempered “hot” chocolate therein. The untempered output line 26 is configured to contain and feed or direct the untempered hot chocolate in the cavity 20 of the first supply vessel 12 to a chocolate transfer or pumping mechanism 33, as shown in FIGS. 1-7. The untempered output line 26 (or any other “line” or mechanism discussed and/or depicted in this disclosure for containing chocolate and directing a flow the chocolate) may be any mechanism or configuration that directs or forms a passage for containing and directing the flow of the chocolate therethrough. The untempered output line 26 may be configured to contain and direct a flow of the untempered hot chocolate in the cavity 20 of the first supply vessel 12 to the transfer mechanism 33 for the untempered output line 26. For example, the untempered output line 26 (or any other “line” or mechanism discussed and/or depicted in this disclosure for containing chocolate and directing a flow thereof) may be a conduit, tube or pipe as shown in FIGS. 1-7. However, the untempered output line 26 (or any other “line” or mechanism discussed and/or depicted in this disclosure for containing chocolate and directing a flow thereof) may not be a conduit, tube or pipe, but may otherwise provide a passageway for the flow of the chocolate therethrough.

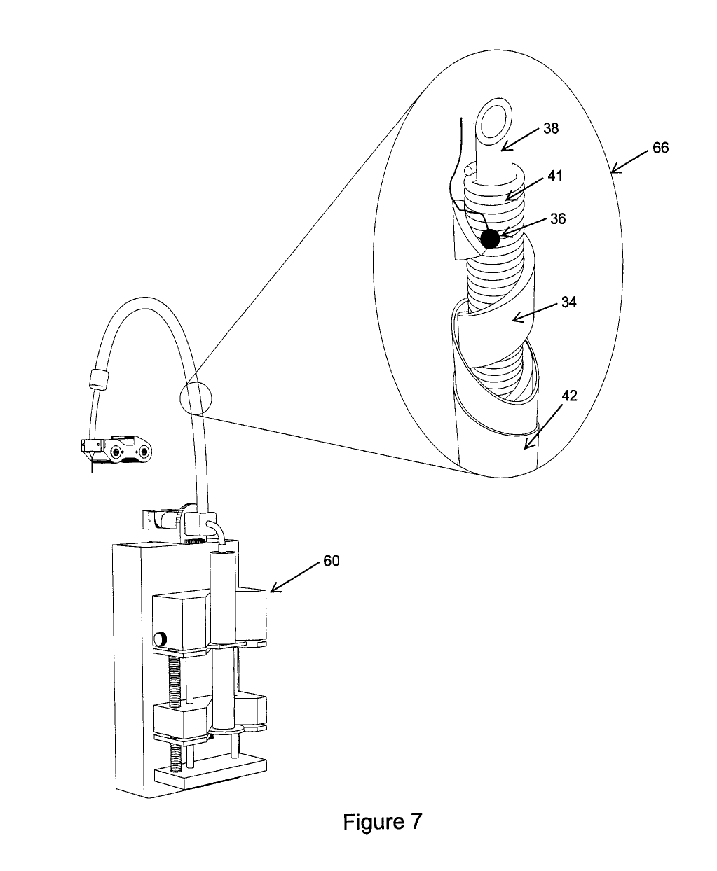

The untempered output line 26 (or any other “line” or mechanism discussed and/or depicted in this disclosure for containing chocolate and directing a flow thereof) may be food-grade or food-safe tubing or piping, and may include a substantially smooth inner surface which defines or forms the passageway in which chocolate is contained and passes through, as shown in FIG. 7. As also shown in FIGS. 1, 3, 4 and 7, the untempered output line 26 (or any other “line” or mechanism discussed and/or depicted in this disclosure for containing chocolate and directing a flow thereof) may include a heating mechanism 34 configured to maintain or control the temperature of at least a portion of the output line 26, and thereby maintain or control the temperature of the chocolate contained therein. In some embodiments, the heating mechanism 34 may be a heat tape or sheet that is provided along at least a substantial length of the output line 26 for heating thereof (or any other “line” or mechanism discussed and/or depicted in this disclosure for containing chocolate and directing a flow thereof). In some embodiments, the heating mechanism 34 may be a resistive heating mechanism that produces heat when electrically powered.

Further, the untempered output line 26 (or any other “line” or mechanism discussed and/or depicted in this disclosure for containing chocolate and directing a flow thereof) may include a temperature measurement mechanism 36 configured to detect or measure the temperature of the heating mechanism 34 and/or another portion of the output line 26 (as discussed below), and thereby detect or measure the temperature of the chocolate contained therein, as shown in FIGS. 1, 3, 4 and 7. The control system 90 may operate or control the heating mechanism 34, such as based on the temperature measured or detected by the temperature measurement mechanism 36, to maintain the temperature of the chocolate contained within the output line 26 such that it remains untempered (i.e., substantially devoid of crystals). In some embodiments, the control system 90 may operate or control the heating mechanism 34, such as based on the temperature measured or detected by the temperature measurement mechanism 36, to maintain the temperature of the chocolate contained within the output line 26 within the range of about 100° F. and about 120° F.

As shown in FIG. 7 the output line 26 (or any other “line” or mechanism discussed and/or depicted in this disclosure for containing chocolate and directing a flow thereof) may include an inner portion 38 that defines the flowpath of the chocolate and is thereby in contact with the chocolate, a protection layer 41 about the inner portion 38, and thermal insulation 42 as an outer layer. In some embodiments, the inner portion 38 may be a Teflon tube, and the protection layer 41 may be a flexible metallic cable in a spiral arrangement about the inner portion 38. As shown in FIG. 7, the heating mechanism 34 of the untempered output line 26 (or any other “line” or mechanism discussed and/or depicted in this disclosure for containing chocolate and directing a flow thereof) may be positioned between the protection layer 41 and the thermal insulation 42, and the temperature measurement mechanism 36 may be positioned adjacent to the heating mechanism 34. In some embodiments, the temperature measurement mechanism 36 may be positioned between the protection layer 41 and the heating mechanism 34. The temperature measurement mechanism 36 may thereby be configured to detect or measure the temperature of the heating mechanism 34 and/or the protection layer 41, and thereby temperature of the chocolate contained within the inner portion 38.

As shown in FIGS. 1-6, the output line 26 may be in fluid communication with the chocolate transfer or pumping mechanism 33. As also shown in FIGS. 1-6, the second supply vessel 14 may include an input or inlet line 32 in fluid connection with the cavity 20 and the chocolate transfer or pumping mechanism 33. In some embodiments, the input line 32 may extend through the lid portion 22 of the second vessel 14 to access the cavity 20 thereof, as shown in FIGS. 1-4. However, the input line 32 may otherwise be in fluid communication with the cavity 20 of the second vessel 14. In some embodiments, the output line 26 and the input line 32 may be integral, or the output line 26 and the input line 32 may be separate and distinct components that are coupled in fluid communication by the transfer or pumping mechanism 33.

As shown in FIGS. 1-6, the chocolate transfer or pumping mechanism 33 may be configured to force the untempered chocolate of the output line 26 into and through the input line 32 to the cavity 20 of the second vessel 14. Stated differently, the chocolate transfer or pumping mechanism 33 may be configured to pump or direct the untempered chocolate of the output line 26 obtained from the untempered first supply vessel 12 to and through the input line 32 to the second vessel 14. The untempered chocolate of the first supply vessel 12 may be fed to the chocolate transfer or pumping mechanism 33 by the output line 26 via gravity, and/or the chocolate transfer or pumping mechanism 33 may create a suction force within the chocolate transfer or pumping mechanism 33 that draws the untempered chocolate from the first supply vessel 12 to the chocolate transfer or pumping mechanism 33. The control system 90 may control or operate the chocolate transfer or pumping mechanism 33 to control the flow of the untempered chocolate from the first supply vessel 12 to the second supply vessel 14 (via the output line 26 and the input line 32).

The chocolate transfer or pumping mechanism 33 may be any mechanism effective or configured to transfer or force the untempered chocolate from the output line 26, through the input line 32 and into the cavity of the second vessel 14. In some embodiments, as shown in FIG. 6, the chocolate transfer or pumping mechanism 33 may be a positive displacement pump, such as a peristaltic pump. For example, the chocolate transfer or pumping mechanism 33 may include a housing including a motor (potentially controlled by the control system 90) and a roller assembly rotated by the motor within a circular pump casing. The chocolate transfer or pumping mechanism 33 may further include a flexible tube or the like fitted inside the circular pump casing, and the roller assembly may compress the flexible tube as it is rotated by the motor. The flexible tube may be a portion of the output line 26, a portion of the input line 32, a combination of portions of the output line 26 and the input line 32, or a separate and distinct component from the output line 26 and/or the input line 32. In some embodiments, the flexible tube may be devoid of the protection layer 41, but may or may not include a heating mechanism (such as the heating mechanism 34 described above).

The configuration (e.g., the construction and operation) of the input line 32 may be substantially similar to that of the output line 26. For example, as shown in FIGS. 1-6 the input line 32 may include a heating mechanism 34 configured to maintain or control the temperature of at least a portion of the input line 32, and thereby maintain or control the temperature of the chocolate contained therein. Further, the input line 32 may include a temperature measurement mechanism 36 configured to detect or measure the temperature of the heating mechanism 34 and/or another portion of the input line 32, and thereby detect or measure the temperature of the chocolate contained therein, as shown in FIGS. 1, 3, 4 and 7. The control system 90 may operate or control the heating mechanism 34, such as based on the temperature measured or detected by the temperature measurement mechanism 36, to maintain the temperature of the chocolate contained within the input line 32 such that it remains untempered (i.e., substantially devoid of crystals). In some embodiments, the control system 90 may operate or control the heating mechanism 34, such as based on the temperature measured or detected by the temperature measurement mechanism 36, to maintain the temperature of the chocolate contained within the input line 32 within the range of about 100° F. and about 120° F.

The second supply vessel 14 may contain, such as initially primed or loaded with, tempered chocolate with a crystallization of about 0.5% to about 3% type V crystals, or about 1% to about 2% type V crystals. In other embodiments, the second supply vessel 14 may temper chocolate within the cavity 20 thereof such that the chocolate is tempered to a crystallization of about 0.5% to about 3% type V crystals, or about 1% to about 2% type V crystals. The system or kit 10 may be configured such that the crystallization of the tempered chocolate contained within the cavity 20 of the first supply vessel 12 is maintained (i.e., maintained within the range of about 0.5% to about 3% type V crystals, or about 1% to about 2% type V crystals). For example, the system or kit 10 may be configured such that control system 90 operates the chocolate transfer mechanism 33 to introduce a particular volume of the untempered chocolate from the first supply vessel 12 at a particular rate and/or time period into the cavity 20 of the second supply vessel 14 such that the crystallization of the tempered chocolate is maintained. In some embodiments, the system or kit 10 may be configured such that control system 90 operates the heating mechanism 24 of the first supply vessel 12, the heating mechanism 34 of the output line 26, and/or the heating mechanism 34 of the input line 32 such that the temperature of the untempered chocolate introduced into the second supply vessel 14 via the input line 32 is of a temperature such that the crystallization of the tempered chocolate of the second supply vessel 14 is maintained. In some embodiments, the system or kit 10 may be configured such that control system 90 operates the heating mechanism 24 of the second supply vessel 14 such that the temperature of the tempered chocolate therein is such that the crystallization thereof is maintained. In some embodiments, the system or kit 10 may be configured such that control system 90 operates the agitation system 40 of the second supply vessel 14 such that the crystallization of the tempered chocolate therein is maintained.

The system or kit 10 may maintain the temperature of the tempered chocolate contained within the cavity 20 of the second supply vessel 14 within the range of about 84° F. and about 92° F. In some embodiments, the temperature of the tempered chocolate within the first supply vessel 12 may be maintained within the range of about 88° F. and about 92° F., or within the range of about 90° F. and about 91° F. As described above, this temperature range of the tempered chocolate contained within the cavity 20 of the second supply vessel 14 may be the optimal chocolate tempering temperature range as it forms the desirable type V crystals, for a particular type of chocolate for example. The system or kit 10 may control the temperature of the tempered chocolate within the second supply vessel 14 via one or more of several different techniques. For example, as discussed above the heating mechanism 24 and/or the agitation system 40 of the second supply vessel 14 may be utilized to control the temperature of the tempered chocolate within the second supply vessel 14. As another example, and also discussed above, the control system 90 may control the amount, timing/frequency and/or temperature of the relatively hotter untempered chocolate of the first supply vessel 12 into the second supply vessel 14 (i.e., the amount, timing/frequency and/or temperature of the hotter untempered chocolate mixed into the tempered chocolate in the second supply vessel 14). In this way, the untempered chocolate from the first supply vessel 12 may be a control point that can be controlled by the system or kit 10 to prevent the tempered chocolate of the second supply vessel 14 from over crystallizing (i.e., above about 3% crystallization, or above about 2% crystallization), not just from the introduction of the crystal-free untempered chocolate but also from the temperature of the introduced untempered chocolate. The volume of the untempered chocolate from the first supply vessel 12 that may need to be added to the tempered chocolate of the second supply vessel 14 (such as during a print operation, as explained further below) to maintain the crystallization thereof can be limited or controlled by varying the temperature of the untempered chocolate introduced into the second supply vessel 14 (e.g., increase temperature to reduce the needed volume). Stated differently, the temperature of the untempered chocolate from the first supply vessel 12 can be utilized to break up any undesirable crystals and maintain the desired crystallization of the tempered chocolate of the second supply vessel 14, and thereby utilized to control the volume of the untempered chocolate needed to maintain the crystallization of the tempered chocolate of the second supply vessel 14.

As shown in FIGS. 1-7, the second supply vessel 14 may include a tempered output line 44 in fluid connection with the bottom or lower portion of the cavity 20 thereof, and therefore the tempered chocolate therein. The tempered output line 44 may be configured to contain and feed or direct the tempered chocolate from the cavity 20 of the second supply vessel 14 into a three-way valve assembly 50, as shown in FIGS. 1-12.

The tempered output line 44 may be substantially similar to the output line 26 and the input line 32. For example, as shown in FIGS. 3-9 the tempered output line 44 may include a heating mechanism 46 configured to maintain or control the temperature of at least a portion of the tempered output line 44, and thereby maintain or control the temperature of the tempered chocolate contained therein. Further, the tempered output line 44 may include a temperature measurement mechanism 48 configured to detect or measure the temperature of the heating mechanism 46 and/or another portion of tempered output line 44, and thereby detect or measure the temperature of the tempered chocolate contained therein, as shown in FIGS. 3-9.

The control system 90 may operate or control the heating mechanism 46, such as based on the temperature measured or detected by the temperature measurement mechanism 48, to maintain the temperature of the tempered chocolate contained within the tempered output line 44 such that it remains tempered with substantially only phase V crystals. In some embodiments, the control system 90 may operate or control the heating mechanism 46, such as based on the temperature measured or detected by the temperature measurement mechanism 48, to maintain the temperature of the tempered chocolate contained within the tempered output line 44 within the range of about 80° F. and about 88° F. In some such embodiments, the tempered chocolate within the output line 44 may be held slighter cooler than the tempered chocolate within the second supply vessel 14. In this way, the output line 44 may slowly control the cooling of the tempered chocolate of the second supply vessel 14 and/or promote slow crystallization and enable formation of further type V cocoa butter crystals therein. In other embodiments, however, the tempered chocolate within the output line 44 may be the substantially same temperature or slighted warmer than the tempered chocolate within the second supply vessel 14, and/or include comparatively more crystallization.

As stated above the system or kit 10 may be configured such that the tempered chocolate in the output line 44 fed from the second supply vessel 14 remains tempered, having substantially only phase V crystals. In some embodiments, the tempered chocolate in the output line 44 may include substantially the same temper as the chocolate within the second supply vessel 14 (i.e., a crystallization of about 0.5% to about 3% type V crystals, or about 1% to about 2% type V crystals). However, the system or kit 10 may be configured such that the output line 44 further tempers the chocolate as compared to the tempered chocolate within the second supply vessel 14, but nonetheless maintains the crystallization of about 0.5% to about 3% type V crystals, or about 1% to about 2% type V crystals.

The three-way valve assembly 50 may be configured to selectively couple the tempered output line 44, and therefore the tempered chocolate therein, in fluid communication with a syringe 54 of a syringe pump 60 via a syringe line 52 in a first state of the three-way valve assembly 50, as shown in FIGS. 1, 2 and 8-12. The three-way valve assembly 50 may also be configured to selectively decouple the tempered output line 44, and therefore the tempered chocolate therein, with the syringe line 52 (and therefore the syringe 54) in a second state of the three-way valve assembly 50 such that they are not in fluid communication. The three-way valve assembly 50 may be configured such that the control system 90 selectively selects or activates the first and second states of the three-way valve assembly 50. As explained further below, the syringe pump 60 may be configured to draw the tempered chocolate from the tempered output line 44, through the three-way valve assembly 50, and into the syringe line 52 and the syringe 54 when the three-way valve assembly 50 is in the first state. When in the three-way valve assembly 50 is in the second state, the tempered chocolate drawn into at least the syringe line 52 from the tempered output line 44 (when the three-way valve assembly 50 was in the first state) may remain in the syringe line 52. In this way, the syringe line 52 may include tempered chocolate therein.

The three-way valve assembly 50 may be any mechanism configured to selectively provide the first and second states (i.e., selectively couple and decouple the tempered output line 44 (and therefore the tempered chocolate therein) with the syringe 54 via the syringe line 52). In some embodiments, the three-way valve assembly 50 may include a housing with a motor coupled to a shaft of a three-way valve via a coupler. The motor may be configured to selectively rotate the shaft of the three-way valve to a first orientation to activate the first state of the three-way valve assembly 50, and to selectively rotate the shaft of the three-way valve to a second orientation to activate the second state of the three-way valve assembly 50.

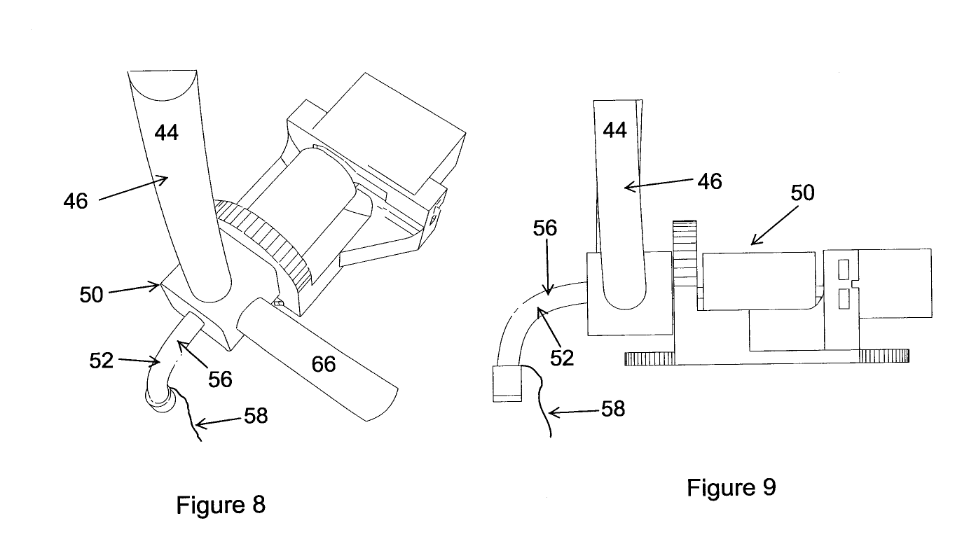

The syringe line 52 may be substantially similar to the tempered output line 44. For example, as shown in FIGS. 8 and 9 the syringe line 52 may include a heating mechanism 56 configured to maintain or control the temperature of at least a portion of the syringe line 52, and thereby maintain or control the temperature of the tempered chocolate contained therein. Further, the syringe line 52 may include a temperature measurement mechanism 58 configured to detect or measure the temperature of the heating mechanism 56 and/or another portion of syringe line 52, and thereby detect or measure the temperature of the tempered chocolate contained therein, as shown in FIGS. 8 and 9.

The system or kit 10 may be configured such that the syringe line 52 maintains the temperature of the tempered chocolate contained therein such that it remains tempered, having substantially only phase V crystals. In some embodiments, the control system 90 may operate or control the heating mechanism 56, such as based on the temperature measured or detected by the temperature measurement mechanism 58, to maintain the temperature of the tempered chocolate contained within the syringe line 52 within the range of about 80° F. and about 88° F. In some such embodiments, the tempered chocolate within the syringe line 52 may be held slighter cooler than the tempered chocolate within the tempered output line 44. In this way, the syringe line 52 may slowly control the cooling of the tempered chocolate of the output line 44 and/or promote slow crystallization and enable formation of further type V cocoa butter crystals therein. In other embodiments, however, the tempered chocolate within the syringe line 52 may be the substantially same temperature or slighted warmer than the tempered chocolate within the tempered output line 44, and/or include comparatively more crystallization.

As stated above the system or kit 10 may be configured such that the tempered chocolate in the syringe line 52 fed from the tempered output line 44 remains tempered with the substantially phase V crystals. In some embodiments, the tempered chocolate in the syringe line 52 may include substantially the same temper as the chocolate within the output line 44 (i.e., a crystallization of about 0.5% to about 3% type V crystals, or about 1% to about 2% type V crystals). However, the system or kit 10 may be configured such that the syringe line 52 further tempers the chocolate as compared to the tempered chocolate within the output line 44, but nonetheless maintains the crystallization of about 0.5% to about 3% type V crystals, or about 1% to about 2% type V crystals.

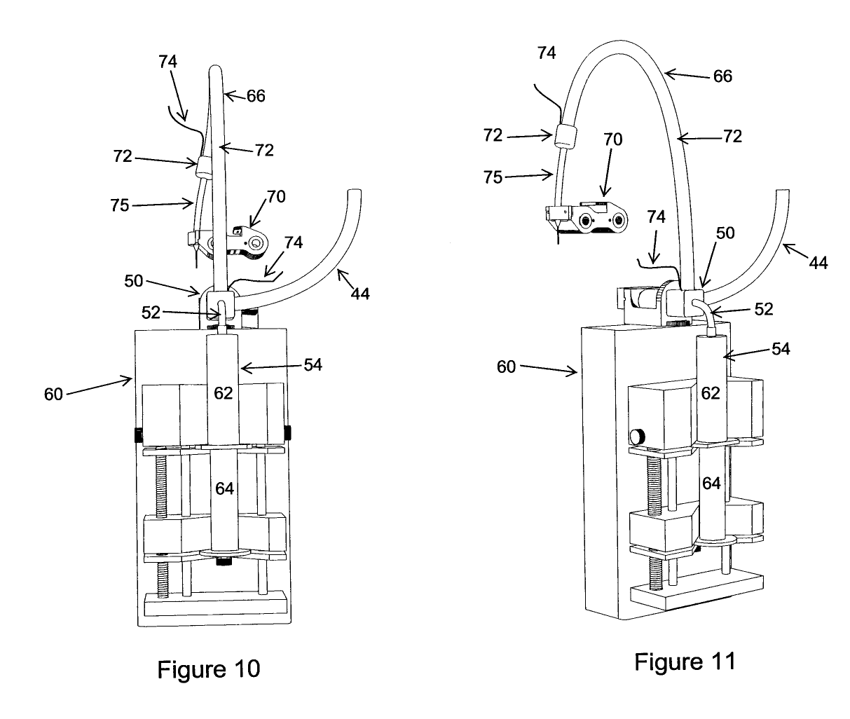

As shown in FIGS. 10-12, the syringe line 52 (and therefore the tempered chocolate therein) may be in fluid communication with the syringe 54 of the syringe pump 60. As also shown in FIGS. 10-12, the syringe 54 may include a hollow barrel portion 62 and a plunger or piston portion 64 movable within (e.g., slidably received within), and substantially sealing off, the barrel portion 62. The barrel portion 62 may include an opening or orifice in fluid communication with the syringe line 52 such that the tempered chocolate within the syringe line 52 is in fluid communication with the barrel portion 62. The plunger portion 64 can be translated along a first direction away from the opening of the barrel portion 62 to expand the space between the plunger portion 64 and the opening within the barrel portion 62 and thereby draw or take in the tempered chocolate from the syringe line 52 into the barrel portion 62 of the syringe 54 to load the syringe 54, as shown in FIGS. 10-12. In order to draw the tempered chocolate from the syringe line 52 into the syringe 54 and/or fill the syringe (i.e., by action of the plunger portion thereof) with a predetermined or predefined volume of the tempered chocolate from the syringe line 52 to load the syringe 54, the three-way valve assembly 50 may be configured or activated in the first state. The first state of the three-way valve assembly 50 may allow the tempered chocolate to flow from the syringe line 52 into the syringe 54 to load the syringe 54, the tempered chocolate to flow from tempered output line 44 into the syringe line 52, and the tempered chocolate to flow from the second supply vessel 14 into the tempered output line 44. The tempered chocolate of the syringe line 52 may flow into the syringe 54 to load the syringe 54 via gravity and/or the syringe may form a suction to “pull” the tempered chocolate therein.

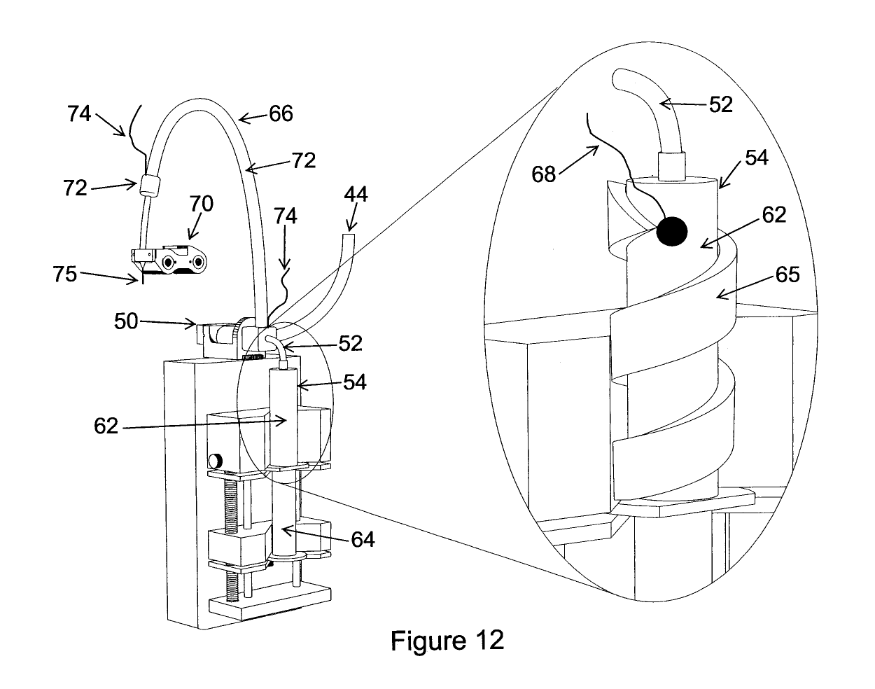

The syringe 54 of the syringe pump 60 may be configured to maintain or control the temperature of the tempered chocolate contained therein when loaded with the tempered chocolate. For example, as shown in FIG. 12 the syringe 54, such as the barrel portion 62 thereof, may include a heating mechanism 65 configured to maintain or control the temperature of at least a portion of the syringe 54 (e.g., the barrel portion 62 thereof), and thereby maintain or control the temperature of the tempered chocolate contained therein. Further, the syringe 54, such as the barrel portion 62, may include a temperature measurement mechanism 68 configured to detect or measure the temperature of the heating mechanism 65 and/or another portion of the syringe 54, and thereby detect or measure the temperature of the tempered chocolate contained therein, as shown in FIG. 12.

The system or kit 10 may be configured such that the syringe 54 maintains the temperature of the tempered chocolate contained therein such that it remains tempered, having substantially only phase V crystals. In some embodiments, the control system 90 may operate or control the heating mechanism 65, such as based on the temperature measured or detected by the temperature measurement mechanism 68, to maintain the temperature of the tempered chocolate contained within the syringe 54 (such as within the barrel portion 62) within the range of about 80° F. and about 88° F. In some such embodiments, the tempered chocolate within the syringe line 52 may be held slighter cooler than the tempered chocolate within the tempered output line 44. In this way, the syringe 54 may slowly control the cooling of the tempered chocolate of the syringe line 52 and/or promote slow crystallization and enable formation of further type V cocoa butter crystals therein. In other embodiments, however, the tempered chocolate within the syringe line 52 may be the substantially same temperature or slighted warmer than the tempered chocolate within the output line 44, and/or include comparatively more crystallization.

As stated above the system or kit 10 may be configured such that the tempered chocolate in the syringe 54 fed from syringe line 52 remains tempered, having substantially only phase V crystals. In some embodiments, the tempered chocolate in the syringe 54 may include substantially the same temper as the chocolate within the syringe line 52 (i.e., a crystallization of about 0.5% to about 3% type V crystals, or about 1% to about 2% type V crystals). However, the system or kit 10 may be configured such that the syringe 54 further tempers the chocolate as compared to the tempered chocolate within the syringe line 52, but nonetheless maintains the crystallization of about 0.5% to about 3% type V crystals, or about 1% to about 2% type V crystals.

The three-way valve assembly 50 may also be configured that when in the second state, the syringe line 52 is in fluid communication with a nozzle 75 via a nozzle input line 66, and thereby the syringe 54 (and the tempered chocolate therein) is in fluid communication with the nozzle 75 via the syringe line 52 and the nozzle input line 66, as shown in FIGS. 1, 2 and 10-12.

For example, once the syringe 54 is loaded with the tempered chocolate, such as a predefined volume of tempered chocolate, the control system 90 may activate the second state of the three-way valve assembly 50 such that the syringe line 52 is no longer in fluid communication with the tempered output line 44 but is in fluid communication with the nozzle input line 66. In such a configuration, condition or state, the system or kit 10 may be “ready” to print tempered chocolate with crystallization of greater than about 3% type V crystals via the nozzle 75 and a 3D printing assembly, as explained further below.

When the second state of the three-way valve assembly 50 is selectively activated (such as by the control system 90) such that the syringe line 52 is in fluid communication with the nozzle input line 66 (and not in fluid communication with the tempered output line 44), the syringe assembly 54 may progressively extrude or force the tempered chocolate therein into and through the syringe line 52. Simultaneously, the tempered chocolate from the syringe 54 that is forced into and through the syringe line 52 will in turn extrude or force the downstream tempered chocolate within the syringe line 52 into and through the nozzle input line 66 via the three-way valve assembly 50. Further, simultaneously, the tempered chocolate from the syringe line 52 that is forced into and through the nozzle input line 66 will in turn extrude or force the downstream tempered chocolate within the nozzle input line 66 into and through the nozzle 75 to print the tempered chocolate. In this way, the syringe assembly 54 may selectively extrude or force tempered chocolate from the nozzle 75 to print the tempered chocolate into a 3D shape via the 3D printing assembly, as explained further below.

The syringe assembly 54 may be configured to extrude or force tempered chocolate from the nozzle 75 (i.e., print the tempered chocolate) with greater than about 3% type V crystals at any flow rate, such as a constant flow rate or a variable and/or intermittent flow rate. In this way, the syringe assembly 54 may print the tempered chocolate according to instructions of the 3D printer 92 (as discussed further below) to achieve a particular 2D or 3D design. For example, the syringe assembly 54 may print the tempered chocolate at a first constant flow rate during a portion of a particular print operation, and print the tempered chocolate a differing second flow rate during another portion of the particular print operation. Similarly, the syringe assembly 54 may print the tempered chocolate at a constant flow rate during a portion of a particular print operation, and print the tempered chocolate at a variable and/or intermittent flow rate during another portion of the particular print operation. For example, the syringe assembly 54 may print the tempered chocolate as a series of beads of tempered chocolate during a portion of a print operation, but as a constant flow of tempered chocolate during another portion of the print operation. As stated above, the design of a particular desired 2D or 3D printed chocolate confection (and the print instructions of the 3D printer 92 corresponding thereto) may dictate the manner or configuration of the flow of tempered chocolate from the nozzle 75 via the syringe assembly 54. In this way, the design of a particular desired 2D or 3D printed chocolate confection (and the print instructions of the 3D printer 92 corresponding thereto) may dictate the manner in which the syringe assembly 54 “prints” the tempered chocolate from the nozzle 75.

The syringe assembly 54 may progressively extrude or force the tempered chocolate therein into and through the syringe line 52 (when the second state of the three-way valve assembly 50 is selectively activated) to, ultimately, extrude or force tempered chocolate from the nozzle 75 (i.e., print the tempered chocolate) via any mechanism or configuration. In one example, as shown in FIG. 10-12 the syringe assembly 54 may include a plunger bracket coupled to the plunger portion 64 of the syringe 54, and a barrel bracket coupled to the barrel portion 62 of the syringe 54. The syringe assembly 54 may also include a mechanism for translating at least one of the plunger bracket and the barrel bracket with respect to the other such that plunger portion 64 is translated along a second direction substantially opposing the first direction toward the opening of the barrel portion 62 to extrude, push or force the tempered chocolate in the barrel portion 62 out of the barrel portion 62 through the opening and into the syringe line 52 to print the tempered chocolate from the nozzle 75, as shown in FIGS. 10-12. As shown in FIG. 12, the syringe assembly 54 may translate at least one of the plunger bracket and the barrel bracket with respect to the other to print the tempered chocolate from the nozzle 75 via a drive screw threadably coupled to at least one of the plunger bracket and the barrel bracket.

As shown in FIGS. 1, 2 and 10-12 as discussed above, nozzle input line 66 may be in fluid connection with the syringe line 52, and therefore the tempered chocolate therein, via the three-way valve 50. Further, the nozzle 75 may be in fluid communication with the nozzle input line 66, and therefore the tempered chocolate therein, and include an opening or orifice for the flow of tempered chocolate therefrom to print the tempered chocolate. The nozzle input line 66 may be configured to contain and feed or direct the tempered chocolate from the syringe line 52 to and through the nozzle 75, as shown in FIGS. 1, 2 and 10-12.

As shown in FIGS. 10-12 the nozzle input line 66 and the nozzle 75 may each include a heating mechanism 72 configured to maintain or control the temperature of at least a portion thereof, and thereby maintain or control the temperature of the tempered chocolate contained therein. Further, the nozzle input line 66 and the nozzle 75 may each include a temperature measurement mechanism 74 configured to detect or measure the temperature of the heating mechanism 72 and/or another portion of the nozzle input line 66 and/or the nozzle 75 may, and thereby detect or measure the temperature of the tempered chocolate contained therein, as shown in FIGS. 10-12.

The system or kit 10 may control (e.g., via the control system 90) the heating mechanisms 72, such as based on the temperature measured or detected by the temperature measurement mechanisms 74, to maintain the temperature of the tempered chocolate contained within the nozzle input line 66 and the nozzle 75 may such that it remains tempered, having substantially only phase V crystals. In some embodiments, the control system 90 may operate or control the heating mechanisms 72, such as based on the temperature measured or detected by the temperature measurement mechanisms 74, to maintain the temperature of the tempered chocolate contained within the nozzle input line 66 and the nozzle 75 within the range of about 75° F. and about 84° F. In some such embodiments, the tempered chocolate within the nozzle input line 66 and/or the nozzle 75 may be held slightly cooler than the tempered chocolate within the syringe line 52 and/or the syringe 54, and/or promote slow crystallization of the tempered chocolate. Similarly, the tempered chocolate within the nozzle 75 may be held slighter cooler than the tempered chocolate within the nozzle input line 66, and/or promote slow crystallization of the tempered chocolate. In this way, the input line 66 and/or the nozzle 75 may slowly control the cooling and/or crystallization of the tempered chocolate of the syringe line 52 and/or the syringe 54 to promote solidification and enable formation of further type V cocoa butter crystals therein upon extrusion from the nozzle 75. In other embodiments, however, the tempered chocolate within the nozzle input line 66 and/or the nozzle 75 may be the substantially same temperature or slighted warmer than the tempered chocolate within the second syringe line 52 and/or the syringe 54, and/or may and/or include comparatively more crystallization. Similarly, in some other embodiments the tempered chocolate within the nozzle 75 may be the substantially same temperature or slighted warmer than the tempered chocolate within the nozzle input line 66, and/or include comparatively more crystallization.

As stated above the system or kit 10 may be configured such that the tempered chocolate in the nozzle input line 66 and the nozzle 75 fed from the syringe line 52 and the syringe 54 remains tempered, having substantially only phase V crystals. In some embodiments, the tempered chocolate in the nozzle input line 66 (and/or the nozzle 75) may include substantially the same temper as the chocolate within the syringe line 52 and/or the syringe 54 (i.e., a crystallization of about 0.5% to about 3% type V crystals, or about 1% to about 2% type V crystals). However, the system or kit 10 may be configured such that the nozzle input line 66 and/or the nozzle 75 further tempers the chocolate as compared to the tempered chocolate within the syringe line 52 and/or the syringe 54 such that the chocolate flowing or extruded from/out of the nozzle 75 includes greater than about 3% type V crystals. The nozzle 75 may further temper the chocolate therein as compared to the tempered chocolate within the nozzle input line 66.

The nozzle 75 may be a heated print head nozzle, which may maintain proper consistency of the tempered chocolate exits the nozzle and onto the build plate 80, as shown in FIG. 1. In some embodiments the nozzle 75 may be configured to accurately position or layout the tempered cholate printed therefrom. For example, the nozzle 75 may include an orifice or opening with an inner diameter within the range of about 0.001 inches and about 0.05 inches (e.g., about 0.023 inches), and may be configured such that the tempered chocolate flows therefrom at a flow rate within the range of about 0.5 ml/min and about 5 ml/min.

After the tempered chocolate is printed from the nozzle 75, the system or kit 10 may further control the cooling and solidification process thereof to maximize the formation of type V crystals (i.e., finish temper as it is printed) and ensure the production of relatively complex and stable 3D shapes via the 3D printing system. For example, the system or kit 10 may at least partially control the environment or atmosphere on or adjacent at least a portion of the build plate 80. For example, as shown in FIGS. 1, 2, 13 and 14, the system and kit 10 may include cooling system 82 configured to control the temperature and humidity of at least a defined portion of and over the build plate 80 encompassing an area in which the system or kit 10 will print, is printing, and/or has printed a tempered chocolate 3D confection. The cooling system 82 of the system or kit 10 may be configured to promote an optimal rate of cooling and solidification (i.e., full tempering) of the printed tempered chocolate. In some embodiments, the cooling system 82 may be configured to cool a defined area such that the area includes a temperature with the range of about 65° F. and about 75° F. Further, in some embodiments the system or kit 10 may be configured to maintain a relative humidity of a defined area such that the area has less than about 50% humidity, such as within the range of about 20% to about 45% humidity.

In one embodiments, the cooling system 82 of the system or kit 10 may include a Peltier plate 84 configured to utilize electrical current and operate as a heat sink to form a relative cold side and a hot side, as shown in FIG. 14. The cooling system 82 may also include circulating fan 86, as also shown in FIG. 14, coupled to the cold side of the Peltier plate 84 and configured to direct or circulate a cool dry airflow (from the cold side of the Peltier plate 84) to the defined portion of and over the build plate 80. The cooling system 82 may also include a heat sink 88 coupled to the hot side of the Peltier plate 84 configured to conduct heat therefrom, and a cooling fan 89 configured to produce an air flow that dissipates heat from the heat sink 88, as shown in FIGS. 1, 2, 13 and 14.

The system or kit 10 thereby forms a continuous, single-direction, closed flow tempered chocolate printing system and kit in which untempered and tempered chocolate are mixed, and the resultant tempered chocolate is continuously fed through the heated lines and through the printing nozzle 75 at a temperature and viscosity that creates correctly tempered 3D chocolate confections with phase V crystals. Advantageously, the system or kit 10 achieves this objective without any of the resultant tempered chocolate being re-tempered (recirculated upstream during the tempering process). The system and kit 10 are closed in that the chocolate flowing through the system and kit 10 continuously moves downstream through the process of the system and kit 10 without exiting the process, or recirculating back upstream, such as for re-tempering. The system and kit 10 may control chocolate tempering by controlling the temperature and cooling process (e.g., slow controlled cooling) of the chocolate flowing through the system or kit 10 to maintaining the chocolate at specific temperature(s) to maintain proper crystalline content and slow cooling and solidification of the chocolate to enable formation of type V cocoa butter crystals in the printed tempered chocolate. The printed tempered chocolate thereby includes a delicious flavor and workable consistency, and aesthetically pleasing texture, while including the ability to form relatively complex and stable 3D shapes.

The 3D printer or printing system, generally indicated by reference numeral 92 in FIGS. 1 and 2, may be any mechanism effective in translating the nozzle 75 and/or the build plate 80 of the printer 92 with respect to the other in at least three-dimensions. The 3D printer 92 may include any nozzle translation mechanism 70 effective in translating the nozzle 75 in three axes of motion (typically x, y and z axes or directions) with respect to the build plate 80. For example, the printer 92 may include stepper motors and/or servo motors employed to translate a nozzle, but any other mechanism may be employed. In some embodiments, the printer system 92 may include an X-Y carriage configured to translate along the X-Y plane, and/or a Z carriage configured to translate along the Z direction. In such embodiments, the nozzle 75 may be configured to couple to the X-Y carriage and/or the Z carriage.

As shown in FIG. 15, the 3D printer 92 may include a printer controller 94 configured to accept data as input, process the input data according to instructions stored in memory thereof, and provide at least one result as output (such as, for example, signals effectuating movement of the nozzle translation mechanism 70). In some embodiments, the printer controller 94 may be a microprocessor. The input instructions may be provided to the printer controller 94 via any mechanism, such as any computer readable memory mechanism. For example, the input instructions provided to the printer controller 94 may be provided via a Secure Digital (SD), a removable flash memory card, and/or firmware. As another example, the input instructions may be provided to the printer controller 94 via a wired connection (e.g., a universal serial bus wired connection) from a device capable of providing the input instructions. As shown in FIG. 15, the temper controller 96 may be in communication with the printer controller 94 via a serial connection.

The input data received by the printer controller 94 of the 3D printer 92 may be G-code provided by computer-aided manufacturing (CAM) software. The printer controller 94 may process the G-code, and output instructions/signals to the nozzle translation mechanism 70 that effectuate movement of nozzle 75 along a particular path. For example, the printer controller 94 may “instruct” at least the nozzle translation mechanism 70 to translate along a particular path in the x axis and y axis along a particular plane or height along the z axis. The G-code may be obtained from an STL file processed by “slicer” software. The STL file may have been produced from a 3D model file.

The system or kit 10 may include a temper controller 96, as shown in FIG. 15. The temper controller 96 may be a microprocessor. The temper controller 96 may be configured to control the syringe assembly 60 (and, potentially, the three-way valve 50) such that the syringe assembly 60 extrudes the tempered chocolate from the nozzle 75 at particular times and at a particular rate (or rates) while the printer controller 94 translates the nozzle 75 to form a 3D object from the extruded tempered chocolate (i.e., a “print operation”). The temper controller 96 may be configured to “read” or input the G-code.

The movement of the nozzle 75 may be controlled or set according to the G-code. The extrusion of the tempered chocolate from the nozzle 75 via the syringe assembly 60 may be based or determined on the movement speed of the nozzle 75 (which may be determined or set by the G-code). For example, the temper controller 96 may calculate or determine an extrusion flow rate/profile based on a particular movement speed of the nozzle 75 (as indicated in the G-code) so as to achieve a particular desired printed structure. In this way, the temper controller 96 may determine the extrusion rate of the tempered chocolate based on the movement speed of the nozzle 75, and control the syringe assembly 60 accordingly. In another embodiment, the temper controller 96 may be configured to control the syringe assembly 60 (and, potentially, the three-way valve 50) such that the syringe assembly 60 extrudes the tempered chocolate from the nozzle 75 at a particular rate/profile according to the G-code.

The temper controller 96 may be configured to control the syringe assembly 60 and the three-way valve 50 prior to a particular print operation such that the syringe assembly 60 is filled with a predetermined or predefined volume of tempered chocolate from the second chocolate supply vessel 14 via the tempered output line 44. In some embodiments, the predetermined or predefined volume of tempered chocolate may be a constant volume, such as a maximum volume the syringe assembly 60 is able to hold or contain (and then extrude or pump). In some embodiments, the predetermined or predefined volume of tempered chocolate within the syringe assembly 60 may correspond to the amount of tempered chocolate needed to print a layer of a particular 3D structure, which may be indicated or determined by the G-code, for example.

In some embodiments, the temper controller 96 may be configured to pause or stop a print operation (i.e., pause or stop the extrusion of chocolate from the nozzle 75 while the nozzle translation mechanism 70 of the printer controller 94 translates the nozzle 75). For example, the system or kit 10 may be configured such that the 3D printer 92 must receive a particular signal or instruction (from the temper controller 96, for example) before proceeding to translate the nozzle 75 to a new z layer (i.e., translate the nozzle 75 upward to print the next layer). By requiring the 3D printer 92 to receive “permission” to move to a new z layer (i.e., the next layer), the print operation can be stopped or paused. As another example, the temper controller 96 may be configured to pause or stop a print operation during printing of a particular z layer.

During such a pause or stop of a print operation, the temper controller 96 may be configured to activate the first state of the three-way valve 50 such that the syringe assembly 60 is in fluid communication with the tempered output line 44 (and, thereby, in fluid communication with the tempered chocolate therein and within the second chocolate supply vessel 14). Thereafter, while the print operation is paused or stopped, the temper controller 96 may cause the syringe assembly 60 to draw the predetermined or predefined volume of tempered chocolate therein from the tempered output line 44 and, potentially, the second chocolate supply vessel 14. As discussed above, the predetermined or predefined volume of chocolate may correspond to the volume needed to print the next layer, if the syringe assembly 60 is refilled between z layers, for example. After the syringe assembly 60 is filled or primed with the predetermined or predefined volume of tempered chocolate, the temper controller 96 may activate the second state of the three-way valve 50 such that the syringe assembly 60 is in fluid communication with the nozzle 75 via the tempered output line 44. The temper controller 96 may be further configured to then restart or continue the print operation according to the G-file (i.e., allow the printer controller 94 to translate the nozzle 75 according to the G-code and extrude the tempered chocolate from the nozzle 75 according to the G-code via the temper controller 96). For example, the 3D printer 92 may receive the “permission” to translate the nozzle 75 to the next z layer, and then translate the nozzle 75 according to the G-code while the syringe assembly 60 respectively extrudes the tempered chocolate.

The temper controller 96 may be configured to pause or stop a print operation (i.e., pause or stop the printer controller 94 from translating the nozzle 75 according to the G-file and/or cause the syringe assembly 60 to stop extruding tempered chocolate from the nozzle 75 according to the G-file), based on the distance that the nozzle 75 travels during a print operation. For example, the temper controller 96 may be configured to read the G-code (e.g., independently of the printer controller 94) and determine the distance that the nozzle 75 will travel, while extruding tempered chocolate via the syringe assembly 60, per z layer. By obtaining the distance that the nozzle 75 will travel while extruding tempered chocolate, the temper controller 96 may be configured to determine the volume of tempered chocolate used and, thereby, when the temper controller 96 communicates with the printer controller 94 and pauses or stops the print operation (e.g., by preventing the z height adjustment), the syringe assembly 60 can be re-filled or loaded with the corresponding volume of tempered chocolate (e.g., by activating the first state of the three-way valve assembly 50 and operating the syringe assembly 60 accordingly). The temper controller 96 may be configured to determine the volume of tempered chocolate used during a print operation of a z layer based on the travel distance of the nozzle 75 while extruding the tempered chocolate (e.g., via the G-code) and a predetermined or predefined value of the volume of tempered chocolate the nozzle 75 extrudes per a unit length of travel of the nozzle 75 (e.g., via the translating mechanism), such as one millimeter. The predetermined or predefined value of the volume of tempered chocolate the nozzle 75 extrudes per a unit length of travel distance of the nozzle 75 may be determined empirically and/or theoretically.

As shown in FIG. 15, the temper controller 96 of the system or kit 10 may be configured to control the agitation assembly 40 and/or the heating mechanism 24 of the first chocolate supply vessel 12 and/or the second chocolate supply vessel 14, and/or the chocolate transfer mechanism 33, such as to control the temper (or lack thereof) of the chocolate within the first chocolate supply vessel 12 and/or the second chocolate supply vessel 14. In some embodiments, the temper controller 96 may control the agitation assemblies 40, 40 via relays 98, and the chocolate transfer mechanism 33 via a power relay 98 and serial communication, as shown in FIG. 15. Similarly, the temper controller 96 of the system or kit 10 may also be configured to control the heating mechanisms of the system or kit 10, such as the heating mechanism 34 of the untempered output line 26, the heating mechanism 34 of the input line 32, the heating mechanism 46 of the tempered output line 44, the heating mechanism 56 of the syringe line 52, the heating mechanism 65 of the syringe pump assembly 60, the heating mechanism 72 of the nozzle input line 66, and/or the heating mechanism 72 of the nozzle 75, or any combination thereof. The temper controller 96 may control the heating mechanisms of the system or kit 10 to control the temper of the chocolate as is passes or travels through the system or kit 10 and, ultimately, out of the nozzle 75 onto the build plate 80. The temper controller 96 may also be configured to control the temper of the chocolate after printing, such as by controlling the cooling system 82 via a power relay 98, as shown in FIG. 15.

The temper controller 96 may control the heating mechanisms of the system or kit 10 via relays 98, as shown in FIG. 15. As also shown in FIG. 15, the temper controller 96 may communicate with the temperature mechanisms of the system or kit 10 via corresponding wiring 99 so as to determine the temperature of the temperature measurement mechanisms (and thereby chocolate proximate thereto), such as the temperature measurement mechanisms 28, the temperature measurement mechanisms 30, the temperature measurement mechanisms 36, the temperature measurement mechanism 48, the temperature measurement mechanism 58, the temperature measurement mechanism 68 and/or the temperature measurement mechanisms 74, or any combination thereof. In some embodiments, the temper controller 96 may be configured to control the heating mechanisms of the system or kit 10 (as discussed above) by proportional-integral-derivative loops (PID loops) utilizing the temperatures obtained by the corresponding temperature measurement mechanisms (as discussed above).

In some embodiments, the system 10 may be constructed as a kit configured to couple to a pre-existing 3D printer 92. In such embodiments, the 3D printer 92 may include a housing with the build plate 80, the printer controller 94, and/or the nozzle translation mechanism 70 coupled thereto, and may be configured to print mediums other than chocolate in two and/or three dimensions. The kit 10 may include any combination of the components described above, and such components may be configured such that the kit 10 couples to a pre-existing 3D printer 92. In this way, the kit 10 may transform or modify a pre-existing 3D printer 92 into a tempered chocolate 3D printer 92 that prints tempered chocolate via a single direction continuous tempering process (i.e., the chocolate is not re-tempering during the process) with at least predominantly phase V crystals.

It is to be understood that the above description is intended to be illustrative, and not restrictive. Numerous changes and modifications may be made herein by one of ordinary skill in the art without departing from the general spirit and scope of the invention as defined by the following claims and the equivalents thereof. For example, the above-described embodiments (and/or aspects thereof) may be used in combination with each other. As another example, rather than including separate and distinct lines of the system or kit 10 that carry the chocolate therein, the lines may be integral or formed through a common component. Similarly, rather than separately heating the lines of the system or kit 10 that carry the chocolate therein (e.g., to control the temper thereof) via separate mechanism, two or more of the lines may be heated collectively, such as by passing two or more of the lines through a heated compartment. As yet another example, the system or kit 10 may be configured to print a particular chocolate printing medium (i.e., type or recipe of chocolate, such as milk chocolate, sweet chocolate, semisweet/bittersweet dark chocolate or white chocolate). As such, parameters of the systems or kit 10 disclosed herein may be particularly configured, such as within any of the ranges enumerated herein, to suit a specific chocolate printing medium. For example, the temperature of the chocolate through the portions of the system or kit 10 may be configured to particularly suit a type of chocolate such that the chocolate is extruded through nozzle (i.e., the viscosity does not cause clogging) and the as-printed chocolate includes greater than about 3% type V crystals. In some embodiments, when the system or kit 10 is utilized to print dark chocolate, the system or kit 10 may be configured such that the temperatures of the dark chocolate through the portions of the system or kit 10 are higher than when the system or kit 10 is utilized to print milk or white chocolate, for example (while within the enumerated temperature ranges). One of ordinary skill in the art can appreciate such tuning of the system or kit 10 to suit a particular chocolate print medium.

In addition, many modifications may be made to adapt a particular aspect, function or material to the teachings of the various embodiments without departing from their scope. While any dimensions and/or types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Also, the term “operably connected” is used herein to refer to both connections resulting from separate, distinct components being directly or indirectly coupled and components being integrally formed (i.e., monolithic). Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A system for printing tempered chocolate, comprising:
a first vessel including a first cavity, the first vessel configured to maintain chocolate within the first cavity at a temperature within the range of about 100 degrees Fahrenheit and about 120 degrees Fahrenheit such that the chocolate is untempered;
a second vessel including a second cavity in fluid communication with the first cavity of the first vessel, the second vessel configured to maintain tempered chocolate within the second cavity at a temperature within the range of about 84 degrees Fahrenheit and about 92 degrees Fahrenheit and a crystallization within the range of about 0.5% to about 3% type V crystals;
a syringe pump including a hollow barrel portion and a plunger portion movable within the barrel portion, the barrel portion and the plunger portion cooperating to form a third cavity of a first predefined volume in a first arrangement of the barrel portion and the plunger portion, and a second predefined volume that is less than the first predefined volume in a second arrangement of the barrel portion and the plunger portion;
a nozzle including an opening; and
a three-way valve configured to selectively include a first state with the third cavity of the syringe pump in fluid communication with the second vessel and a second state with the nozzle in fluid communication with the third cavity of the syringe pump,
wherein the syringe pump is configured to selectively translate at least one of the hollow barrel portion and the plunger portion with respect to the other from the second arrangement to the first arrangement when the three-way valve is in the first state to draw the tempered chocolate from the second vessel into the third cavity, and selectively translate at least one of the hollow barrel portion and the plunger portion with respect to the other from the first arrangement to the second arrangement when the three-way valve is in the second state to extrude the tempered chocolate through opening of the nozzle, and
wherein the system forms a direct flow of the tempered chocolate from the second vessel through the opening of the nozzle.

2. The system of claim 1, wherein the second vessel is configured to maintain tempered chocolate within the second cavity at a crystallization within the range of about 1% to about 2% type V crystals.

3. The system of claim 1, wherein the system continuously tempers the tempered chocolate from the second vessel through the opening of the nozzle, and wherein the tempered chocolate flowing though the opening of the nozzle includes a crystallization greater than 3%.

4. The system of claim 1, further comprising a pump configured to pump a portion of the untempered chocolate of the first vessel into the second vessel such that the crystallization of the tempered chocolate within the second vessel is maintained within the range of about 0.5% to about 3% type V crystals.

5. The system of claim 1, further comprising at least one output line configured to direct a flow of untempered chocolate from the first cavity of the first vessel to the second cavity of the second vessel and includes at least one heating mechanism configured to maintain the tempered chocolate therein at a temperature within the range of about 100 degrees Fahrenheit and about 120 degrees Fahrenheit such that the chocolate is untempered.

6. The system of claim 5, wherein the at least one output line includes at least one temperature measurement mechanism configured to detected the temperature of at least the at least one heating mechanism, and wherein the system further comprises a control system configured to control the temperature of the at least one heating mechanism based on the temperature detected by the at least one temperature measurement mechanism.

7. The system of claim 1, further comprising at least one tempered output line configured to direct a flow of tempered chocolate from the second cavity of the second vessel to the three-way valve, wherein the at least one tempered output line includes at least one heating mechanism configured to maintain the tempered chocolate therein at a temperature within the range of about 80 degrees Fahrenheit and about 88 degrees Fahrenheit and a crystallization within the range of about 0.5% to about 3% type V crystals.

8. The system of claim 7, wherein the at least one tempered output line includes at least one temperature measurement mechanism configured to detected the temperature of at least the at least one heating mechanism, and wherein the system further comprises a control system configured to control the temperature of the at least one heating mechanism based on the temperature detected by the at least one temperature measurement mechanism.

9. The system of claim 1, wherein the syringe pump includes at least one heating mechanism configured to maintain the tempered chocolate within the third cavity at a temperature within the range of about 80 degrees Fahrenheit and about 88 degrees Fahrenheit and a crystallization within the range of about 0.5% to about 3% type V crystals.

10. The system of claim 9, wherein the syringe pump includes at least one temperature measurement mechanism configured to detected the temperature of at least the at least one heating mechanism, and wherein the system further comprises a control system configured to control the temperature of the at least one heating mechanism based on the temperature detected by the at least one temperature measurement mechanism.

11. The system of claim 1, further comprising at least one nozzle input line configured to direct a flow of tempered chocolate from the three-way valve to the nozzle.

12. The system of claim 11, wherein the at least one nozzle input line includes at least one heating mechanism configured to maintain the tempered chocolate therein at a temperature within the range of about 75 degrees Fahrenheit and about 84 degrees Fahrenheit and a crystallization within the range of about 0.5% to about 3% type V crystals.

13. The system of claim 12, wherein the at least one nozzle input line includes at least one temperature measurement mechanism configured to detected the temperature of the at least one heating mechanism, and wherein the system further comprises a control system configured to control the temperature of the at least one heating mechanism based on the temperature detected by the at least one temperature measurement mechanism.

14. The system of claim 1, wherein at least one of the first and second vessels include a heating mechanism configured to maintain the temperature of the chocolate therein.

15. The system of claim 1, wherein at least one of the first and second vessels include a temperature measurement mechanism positioned interior of the first and second cavities, respectively, configured to detect the temperature of the chocolate therein, and an agitation mechanism configured to agitate the chocolate contained therein.

16. The system of claim 1, further comprising a cooling system configured to control the temperature and/or humidity of the environment about at least the opening of the nozzle.

17. The system of claim 1, further comprising a control system configured to selectively translate the hollow barrel portion and the plunger portion of the syringe pump between the first and second arrangements, to selectively activate the first and second states of the three-way valve, and to control the first and second vessels.

18. The system of claim 17, wherein the system further comprises at least one of:
at least one first line configured to direct the flow of untempered chocolate from the first vessel to the second vessel, at least one second line configured to direct the flow of tempered chocolate from the second vessel to the three-way valve, and at least one third line configured to direct the flow of tempered chocolate from the three-way valve to the nozzle; and
at least one heating mechanism configured to heat the chocolate within at least one of the at least one first line, the at least one second line and the at least one third line, wherein the system further includes at least one temperature measurement mechanism configured to detected the temperature of at least the at least one heating mechanism, and wherein the control system controls the temperature of the at least one heating mechanism based on the temperature detected by the at least one temperature measurement mechanism.

19. The system of claim 1, wherein the system includes a 3D printer including a housing, a build plate, a nozzle translation mechanism coupled to the nozzle configured to translate the nozzle in three dimensions with respect to the build plate, and a printer controller configured to control the nozzle translation mechanism based on computer readable instructions.

20. A kit for printing tempered chocolate with a 3D printer including a build plate, a nozzle translation mechanism configured to translate in three dimensions with respect to the build plate, and a printer controller configured to control the nozzle translation mechanism based on computer readable instructions, comprising:
a first vessel including a first cavity, the first vessel configured to maintain chocolate within the first cavity at a temperature within the range of about 100 degrees Fahrenheit and about 120 degrees Fahrenheit such that the chocolate is untempered;
a second vessel including a second cavity connectable in fluid communication with the first cavity of the first vessel, the second vessel configured to maintain tempered chocolate within the second cavity at a temperature within the range of about 84 degrees Fahrenheit and about 92 degrees Fahrenheit and a crystallization within the range of about 0.5% to about 3% type V crystals;
a syringe pump including a hollow barrel portion and a plunger portion movable within the barrel portion, the barrel portion and the plunger portion cooperating to form a third cavity of a first predefined volume in a first arrangement of the barrel portion and the plunger portion, and a second predefined volume that is less than the first predefined volume in a second arrangement of the barrel portion and the plunger portion;
a nozzle including an opening configured to couple with the nozzle translation mechanism;
a three-way valve configured to selectively include a first state with the third cavity of the syringe pump in fluid communication with the second vessel and a second state with the nozzle in fluid communication with the third cavity of the syringe pump; and
a temper controller configured to communication with the printer controller and, based on the computer readable instructions, to:
selectively activate the first state of the three-way valve and translate at least one of the hollow barrel portion and the plunger portion of the syringe pump with respect to the other from the second arrangement to the first arrangement to draw tempered chocolate from the second vessel into the third cavity; and
selectively activate the second state of the three-way valve and translate at least one of the hollow barrel portion and the plunger portion with respect to the other from the first arrangement to the second arrangement to extrude tempered chocolate through the opening of the nozzle,
wherein the kit is configured to form a direct flow of the tempered chocolate from the second vessel through the opening of the nozzle.

21. The kit of claim 20, wherein the kit includes a 3D printer including a housing, a build plate, a nozzle translation mechanism coupled to the nozzle configured to translate the nozzle in three dimensions with respect to the build plate, and a printer controller configured to control the nozzle translation mechanism based on computer readable instructions.

22. A method of printing tempered chocolate, comprising:
maintaining chocolate within a first cavity of a first vessel at a temperature within the range of about 100 degrees Fahrenheit and about 120 degrees Fahrenheit such that the chocolate is untempered;
maintaining tempered chocolate within a second cavity of a second vessel in fluid communication with the first cavity at a temperature within the range of about 84 degrees Fahrenheit and about 92 degrees Fahrenheit and a crystallization within the range of about 0.5% to about 3% type V crystals;
selectively activating a first state of a three-way valve to couple a syringe pump in fluid communication with the second vessel;
translating at least one of a hollow barrel portion and a plunger portion of the syringe pump with respect to the other to draw tempered chocolate from the second vessel into a third cavity of the syringe pump;
selectively activating a second state of the three-way valve to couple the syringe pump in fluid communication with a nozzle; and
translating at least one of the hollow barrel portion and the plunger portion of the syringe pump with respect to the other to extrude tempered chocolate through an opening of the nozzle,
wherein the method forms a direct flow of the tempered chocolate from the second vessel through the opening of the nozzle.
